(19) United States
(12) Patent Application Publication
(10) Pub. No.: US 2010/0088309 A1
(43) Pub. Date: Apr. 8, 2010

(54) EFFICIENT LARGE-SCALE JOINING FOR QUERYING OF COLUMN BASED DATA ENCODED STRUCTURES

(75) Inventors: Cristian Petculescu, Redmond, WA (US); Amir Netz, Bellevue, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 12/335,341

(22) Filed: Dec. 15, 2008

Related U.S. Application Data
(60) Provisional application No. 61/102,855, filed on Oct. 5, 2008.

(51) Int. Cl. G06F 17/30

(52) U.S. Cl. 707/714; 707/E17.009

(57) ABSTRACT

The subject disclosure relates to querying of column based data encoded structures enabling efficient query processing over large scale data storage, and more specifically, with respect to join operations. Initially, a compact structure is received that represents the data according to a column based organization, and various compression and data packing techniques, already enabling a highly efficient and fast query response in real-time. On top of already fast querying enabled by the compact column oriented structure, a scalable, fast algorithm is provided for query processing in memory, which constructs an auxiliary data structure, also column-oriented, for use in join operations, which further leverages characteristics of in-memory data processing and access, as well as the column-oriented characteristics of the compact data structure.

### CROSS REFERENCE TO RELATED APPLICATIONS

This application claims priority to U.S. Provisional Patent Application Ser. No. 61/102,855, filed on Oct. 5, 2008, entitled “EFFICIENT LARGE-SCALE JOINING FOR QUERYING OF COLUMN BASED DATA ENCODED STRUCTURES”, the entirety of which is incorporated herein by reference.

### TECHNICAL FIELD

The subject disclosure generally relates to efficient column based join operations relating to queries over large amounts of data.

### BACKGROUND

By way of background concerning conventional data query systems, when a large amount of data is stored in a database, such as when a server computer collects large numbers of records, or transactions, of data over long periods of time, other computers sometimes desire access to that data or a targeted subset of that data. In such case, the other computers can query for the desired data via one or more query operators. In this regard, historically, relational databases have evolved for this purpose, and have been used for such large scale data collection, and various query languages have developed which instruct database management software to retrieve data from a relational database, or a set of distributed databases, on behalf of a querying client.

Traditionally, relational databases have been organized according to rows, which correspond to records, having fields. For instance, a first row might include a variety of information for its fields corresponding to columns (name1, age1, address1, sex1, etc.), which define the record of the first row and a second row might include a variety of different information for fields of the second row (name2, age2, address2, sex2, etc.). However, conventional querying over enormous amounts of data, or retrieving enormous amounts of data for local querying or local business intelligence by a client have been limited in that they have not been able to meet real-time or near real-time requirements. Particularly in the case in which the client wishes to have a local copy of up-to-date data from the server, the transfer of such large scale amounts of data from the server given limited network bandwidth and limited client cache storage has been impractical to date for many applications.

By way of further background, due to the convenience of conceptualizing differing rows as differing records with relational databases as part of the architecture, techniques for reducing data set size have thus far focused on the rows due to the nature of how relational databases are organized. In other words, the row information preserves each record by keeping all of the fields of the record together on one row, and traditional techniques for reducing the size of the aggregate data have kept the fields together as part of the encoding itself.

It would thus be desirable to provide a solution that achieves simultaneous gains in data size reduction and query processing speed. In addition to applying compression in a way that yields highly efficient querying over large amounts of data, it would be further desirable to provide an improved data querying technique in a query environment in which it can be anticipated that the same or similar queries will be executed. In this regard, where the same or similar data or subsets of data are implicated by a set of separate queries in an environment in which many queries are run according to a variety of data intensive applications, it is desirable to attempt to re-use results.

More specifically, in query processing, in a high percentage of cases, a query will implicate the need to join multiple tables in order to achieve the goal of combining result sets from multiple tables. For example, if sales data is stored in a sales table while product details are stored in a product table, an application may want to report sales broken down by product categories. In SQL, this can be expressed as a “select from” construct such as:
Select product-category, sum(amount) from sales inner join product on sales.sku=product.sku

For the example above, conventional ways to satisfy the join operation include hash join, merge join and nested loop join operations. Hash join builds a hash structure on product by stock keeping unit (SKU) to product_category and looks up every SKU from the sales table into this hash structure. Merge join sorts both the sales records and the product table by SKU and then synchronously scans the two sets. Nested loop join scans the products table for each row in the sales table, i.e., a nested loop join runs a query on the product for each row in the sales table. However, these conventional ways are either not particularly efficient, e.g., nested loop join, or introduce significant overhead at the front end of the process, which may not be desirable for real-time query requirements over massive amounts of data. Thus, a fast and scalable algorithm is desired for querying over large amounts of data in a data intensive application environment.

The above-described deficiencies of today's relational databases and corresponding query techniques are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

Embodiments of querying of column based data encoded structures are described enabling efficient query processing over large scale data storage, and more specifically with respect to join operations. Initially, a compact structure is received that represents the data according to a column based organization, and various compression and data packing techniques, already enabling a highly efficient and fast query response in real-time. On top of already fast querying enabled by the compact column oriented structure, a scalable, fast algorithm is provided for query processing in memory, which constructs an auxiliary data structure for use in join operations, which further leverages characteristics of in-memory data processing and access, as well as the column-oriented characteristics of the compact data structure.

These and other embodiments are described in more detail below.

### BRIEF DESCRIPTION OF THE DRAWINGS

Various non-limiting embodiments are further described with reference to the accompanying drawings in which:

FIG. 1 is a flow diagram of a general process for forming a cache in accordance with an embodiment;

FIG. 2 is a block diagram illustrating the formation of an auxiliary cache 240 used in connection with processing queries;

FIG. 3 illustrates that the work of in memory client-side processing of the column data received in connection with a query can be split among multiple cores so as to share the burden of processing large numbers of rows across the column organization;

FIG. 4 is a block diagram illustrating that the auxiliary cache can be used across the segments of column oriented compacted data structures during query processing;

FIG. 5 is a first flow diagram illustrating the application of a technique that uses a lazy cache to skip certain join operations of a query as described herein;

FIG. 6 is a second flow diagram illustrating the application of a technique that uses a lazy cache to skip certain join operations of a query as described herein;

FIG. 7 is a general block diagram illustrating a column based encoding technique and in memory client side processing of queries over the encoded data;

FIG. 8 is a block diagram illustrating an exemplary non-limiting implementation of encoding apparatus employing column based encoding techniques;

FIG. 9 is a flow diagram illustrating an exemplary non-limiting process for applying column based encoding to large scale data;

FIG. 10 is an illustration of column based representation of raw data in which records are broken into their respective fields and the fields of the same type are then serialized to form a vector;

FIG. 11 is a non-limiting block diagram exemplifying columnization of record data;

FIG. 12 is a non-limiting block diagram illustrating the concept of dictionary encoding;

FIG. 13 is a non-limiting block diagram illustrating the concept of value encoding;

FIG. 14 is a non-limiting block diagram illustrating the concept of bit packing applied in one aspect of a hybrid compression technique;

FIG. 15 is a non-limiting block diagram illustrating the concept of run length encoding applied in another aspect of a hybrid compression technique;

FIG. 16 is a block diagram illustrating an exemplary non-limiting implementation of encoding apparatus employing column based encoding techniques;

FIG. 17 is a flow diagram illustrating an exemplary non-limiting process for applying column based encoding to large scale data in accordance with an implementation;

FIGS. 18-19 are exemplary illustrations of ways to perform a greedy run length encoding compression algorithm, including the optional application of a threshold savings algorithm for applying an alternative compression technique;

FIG. 20 is a block diagram further illustrating a greedy run length encoding compression algorithm;

FIG. 21 is a block diagram illustrating a hybrid run length encoding and bit packing compression algorithm;

FIG. 22 is a flow diagram illustrating the application of a hybrid compression technique that adaptively provides different types of compression based on a total bit savings analysis;

FIG. 23 block diagram illustrating the sample performance of the column based encoding to reduce an overall size of data in accordance with various embodiments of the subject disclosure;

FIG. 24 illustrates a bucketization process that can be applied to column based encoded data with respect to transitions between pure and impure areas, and vice versa;

FIG. 25 illustrates impurity levels with respect to bucketization of the columns in accordance with an embodiment;

FIG. 26 illustrates the efficient division of query/scan operators into sub-operators corresponding to the different types of buckets present in the columns relevant to the current query/scan;

FIG. 27 illustrates the power of column based encoding where resulting pure buckets represent more than 50% of the rows of the data;

FIG. 28 illustrates exemplary non-limiting query building blocks for query languages for specifying queries over data in a standardized manner;

FIG. 29 illustrates representative processing of a sample query requested by a consuming client device over large scale data available via a network;

FIG. 30 is a flow diagram illustrating a process for encoding data according to columns according to a variety of embodiments;

FIG. 31 is a flow diagram illustrating a process for bit packing integer sequences according to one or more embodiments;

FIG. 32 is a flow diagram illustrating a process for querying over the column based representations of data;

FIG. 33 is a block diagram representing exemplary non-limiting networked environments in which various embodiments described herein can be implemented; and

FIG. 34 is a block diagram representing an exemplary non-limiting computing system or operating environment in which one or more aspects of various embodiments described herein can be implemented.

### DETAILED DESCRIPTION

### Overview

As a roadmap for what follows, an overview of various embodiments is first described and then exemplary, non-limiting optional implementations are discussed in more detail for supplemental context and understanding. Then, some supplemental context regarding the column based encoding for packing large amounts of data are described including an embodiment that adaptively trades off the performance benefits of run length encoding and bit packing via a hybrid compression technique. Lastly, some representative computing environments and devices in which the various embodiments can be applied are set forth.

As discussed in the background, among other things, conventional systems do not adequately handle the problem of reading tremendous amounts of data from a server, or other data store in “the cloud,” in memory very fast due to limits on current compression techniques, limits on transmission bandwidth over networks and limits on local cache memory. The problem compounds when many queries are executed by a variety of different data intensive applications with real-time requirements.

Accordingly, in various non-limiting embodiments, a technique is applied on top of an efficient column oriented encoding of large amounts of data, which simultaneously compacts and organizes the data, making later scan/search/query operations over the data substantially more efficient. In various embodiments, an auxiliary column-oriented data structure is generated in local cache memory as queries take place to inform future queries, making queries faster over time without introducing significant overhead to generate complex data structures at the front end.

In one embodiment, initially, a “lazy” cache is formed according to a step involving negligible overhead. Next, the cache is populated during a query wherever a miss occurs, and then the cache is used in connection with deriving the result set.

Since the auxiliary data structure and the compacted data structure are both organized according to a column-based view of the data, re-use of data is achieved efficiently since results represented in local cache memory can be quickly substituted, where applicable, in a join operation applying to the columns of the compacted data structure, resulting in overall faster and more efficient joining of the results implicated by a given query.

Column Based Data Joining of Data with Auxiliary Cache

As mentioned in the overview, column oriented encoding and compression can be applied to large amounts of data to compact and simultaneously organize the data to make later scan/search/query operations over the data substantially more efficient. In various embodiments, on top of such column oriented encoding and scanning techniques, a scalable, fast algorithm is provided that takes advantage of in-memory characteristics as well as the column-oriented characteristics of the compact encoding of data.

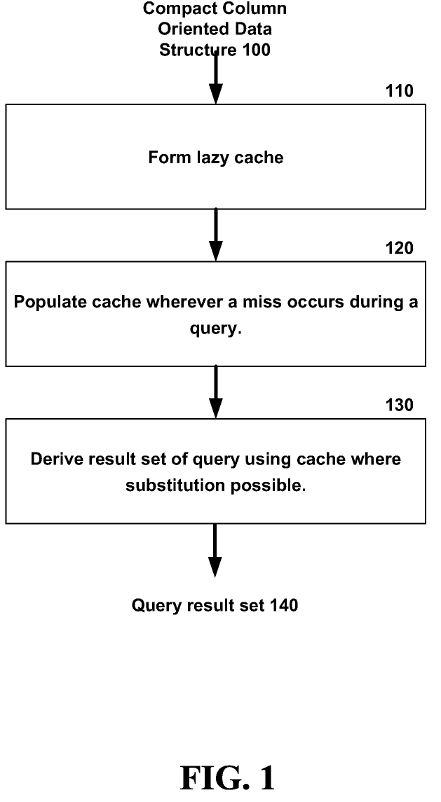

In one embodiment, as shown in FIG. 1, initially, a compact column oriented data structure 100 is received over which queries can be processed according to the scanning techniques described in detail in the next section. In general, to speed up query processing in a data intensive environment, at 110, a “lazy” cache is formed according to a step involving negligible overhead. In one embodiment, the lazy cache is constructed as a vector that is not initialized, or uninitialized, at the beginning. Next, at 120, the cache is populated during a query wherever a miss occurs. Then, at 130, the cache is used in connection with deriving the result set 140.

In this regard, performing join operations implicated by a query over large amounts of data is efficiently performed in various embodiments presented herein since expensive, front end, sort or hash operations implicated by conventional systems are avoided.

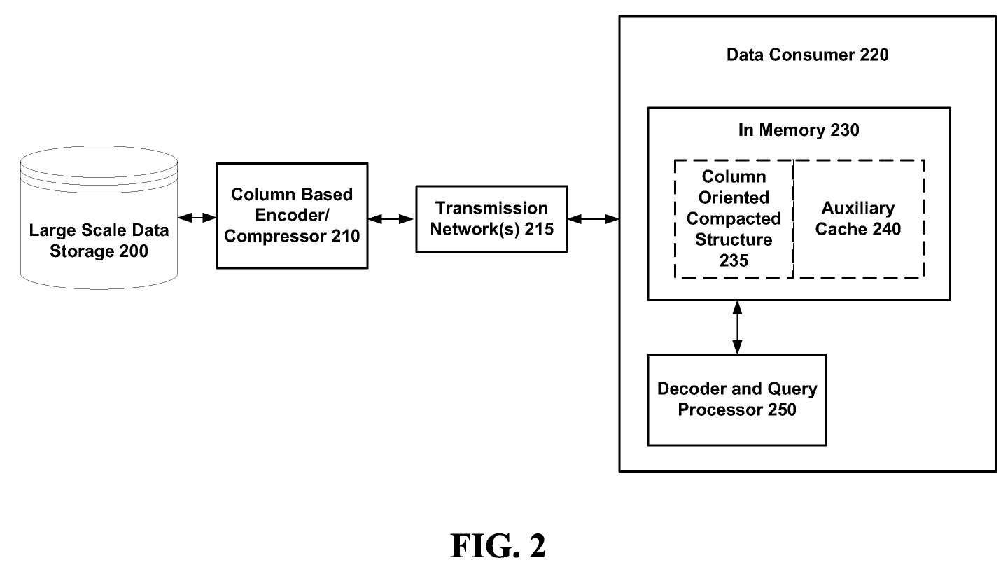

Generally, a system using compacted column oriented structures is illustrated in FIG. 2. The column oriented compacted structures 235 are retrieved from a large scale data store 200 to satisfy a query. A column based encoder 210 compresses the data from storage 200 for receipt in memory 230 over transmission networks 215 for fast decoding and scanning by component 250 of a data consumer 220. The column oriented compacted structures 235 are a set of compressed column sequences corresponding to the column values as encoded and compressed according to the techniques described in more detail below.

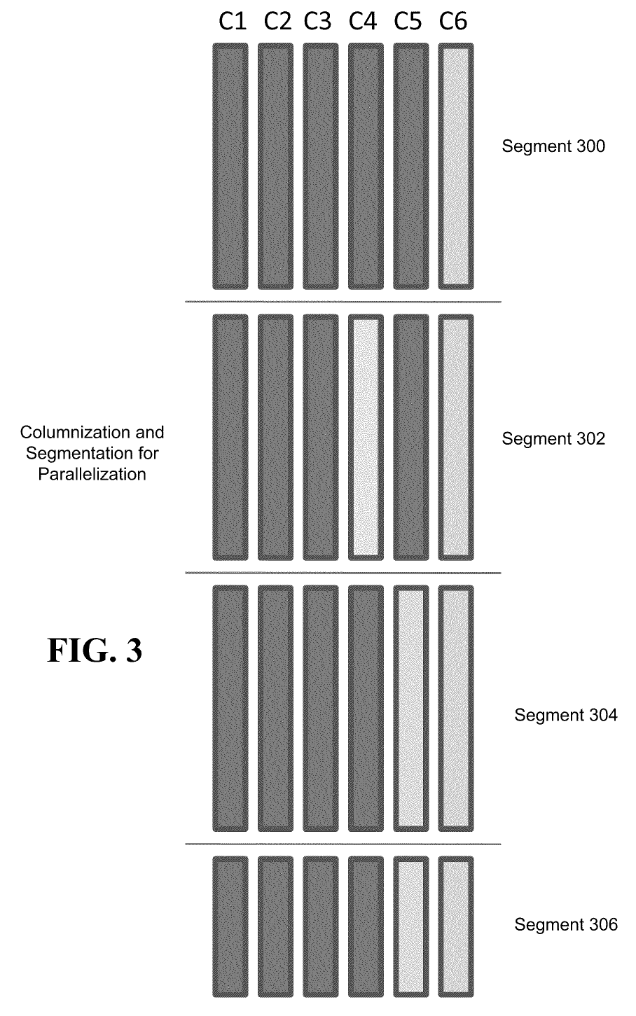

In one embodiment, when compressed columns according to the above-described technique are loaded in memory on a consuming client system, the data is segmented across each of the columns C1, C2, C3, C4, C5, C6 to form segments 300, 302, 304, 306, etc as shown in FIG. 3. In this regard, since each segment can include 100s of millions of rows or more, parallelization improves the speed of processing or scanning the data, e.g., according to a query. The results of each segment are aggregated to form a complete set of results while each segment is processed separately.

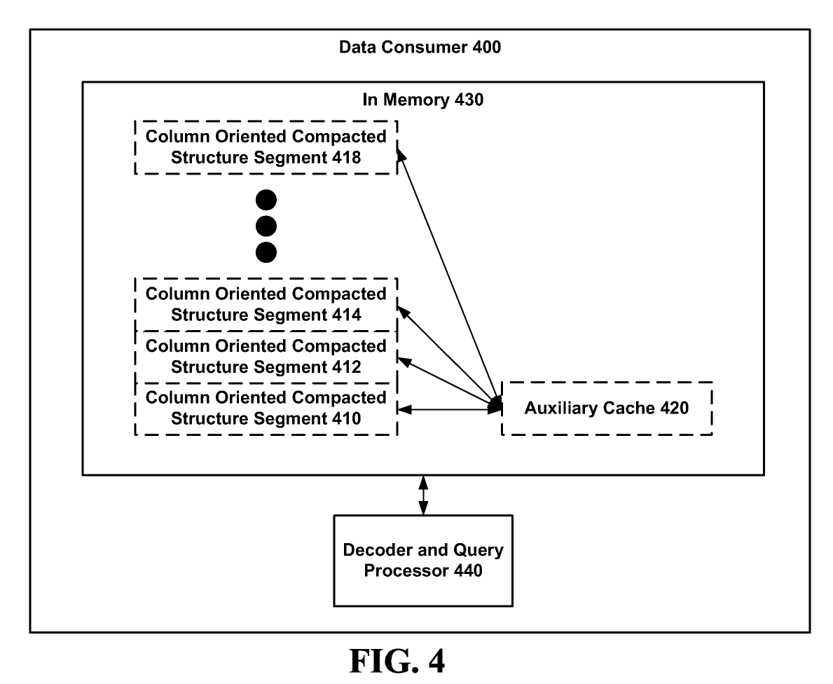

As shown in FIG. 4, initially, a lazy cache 420 is formed in memory 430 of a data consumer 400 where fast querying is to be performed. In one embodiment, as shown, the lazy cache 420 is shared by the different segments 410, 412, 414, . . . , 418 of a compacted column-oriented data structure. The segments are also the unit of parallelism used in connection with scanning on a multi-processor basis as described below. In this regard, in accordance with various embodiments, an auxiliary cache 420 can thus be used by decoder and query processor 440 to create processing shortcuts with respect to join operations described in more detail as follows, and which can be used across segments 410, 412, 414, . . . , 418.

In one embodiment, the cache 420 is initialized with −1 (not initialized), which is an inexpensive operation. Then, in the context of the example given in the background where an application may want to report sales broken down by product categories, over the lifetime of the query, the cache 420 becomes populated with matching data IDs from the products table, though only if needed. For instance, if the sales table is filtered heavily by another table, e.g., customers, then many of the rows in the vector will stay uninitialized. This represents a performance benefit over traditional solutions since it achieves cross-table filtering benefits.

With respect to populating the lazy cache, when the scan happens, the foreign key data id, e.g., sales.sku in the example used herein, is used as an index into the lazy scan vector of the lazy cache 420. If the value is −1, the actual join happens with the appropriate columns of segments 410, 412, 414, . . . , 418. Traversal of the relationships thus occurs on the fly and the data IDs of the column of interest are retrieved, e.g., product category in the present example. If the value is not −1, on the other hand, it means the join phase can be skipped, instead utilizing the value, yielding tremendous performance savings. Another benefit is that no locking need be performed as in a relational database since writing in the vector in memory 430 is an atomic operation of a core processor data type. While a join may be resolved twice, prior to the −1 value being changed, this would typically be a rare case. Accordingly, the value from the lazy cache can be substituted with the actual column value. Over time, the value of the cache 420 increases as more queries are performed by data consumer 400.

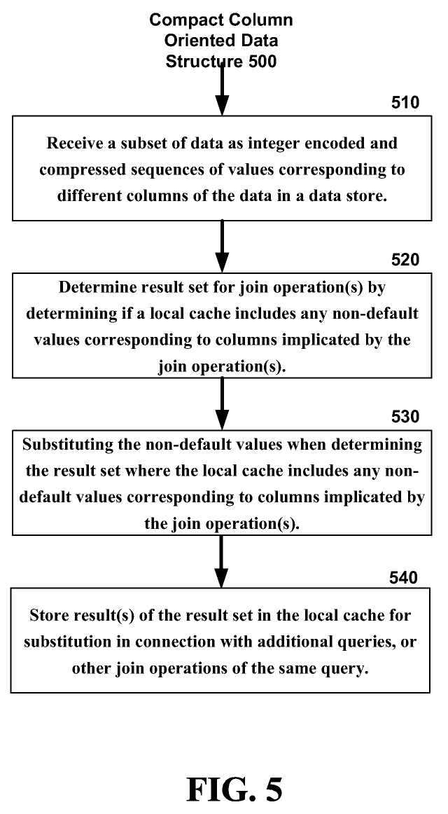

FIG. 5 is a flow diagram illustrating the application of a technique that uses a lazy cache to skip certain join operations of a query as described herein. After compact column oriented data structure 500 is received, at 510, a subset of data is received as integer encoded and compressed sequences of values corresponding to different columns of the data in a data store. At 520 a result set for join operation(s) is determined by determining if a local cache includes any non-default values corresponding to columns implicated by the join operation(s). At 530, the non-default values are substituted when determining the result set where the local cache includes any non-default values corresponding to columns implicated by the join operation(s). At 540, the result(s) of the result set are stored in the local cache for substitution in connection with additional queries, or other join operations of the same query.

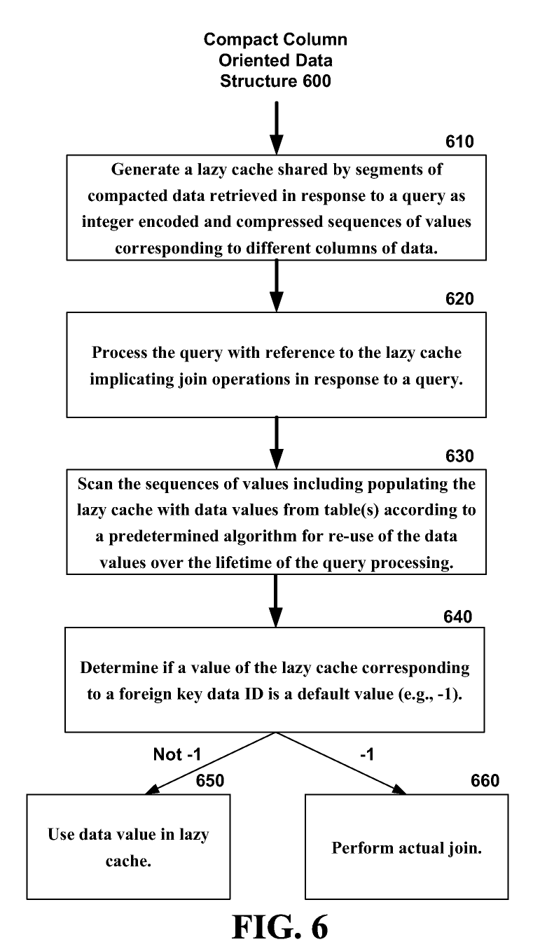

FIG. 6 is another flow diagram illustrating the application of a technique that uses a lazy cache to skip certain join operations of a query as described herein. After compact column oriented data structure 600 is received, at 610, a lazy cache is generated, which is shared by segments of compacted data retrieved in response to a query as integer encoded and compressed sequences of values corresponding to different columns of data. At 620, the query is processed with reference to the lazy cache implicating join operations in response to a query.

At 630, the compacted sequences of values are scanned and the lazy cache is populated with data values from table(s) according to a predetermined algorithm for re-use of the data values over the lifetime of the query processing. In one embodiment, the predetermined algorithm includes, at 640, determining if a value of the lazy cache corresponding to a foreign key data ID is a default value (e.g., −1). If not, then at 650, the data value in the lazy cache can be used, i.e., the −1 value was replaced in the lazy cache for potential re-use. If so, then at 660, the actual join over the sequences of values can be performed.

The term “lazy” as used herein refers to the notion that a lot of advance work need not be performed upfront, and instead the cache becomes populated over time and as needed consistent with queries processed by a given system. A non-limiting advantage of the in memory cache is that it is lockless, and in addition, the cache can be shared across segments (unit of parallelization, see FIGS. 3-4). A cross dimension filtered cache is thus provided that can be populated by a variety of applications processing queries. As a result, speed and scalability, e.g., for filtered queries implicating join operations, are increased by an order of magnitude.

### Supplemental Context RE: Column Based Data Encoding

As mentioned in the overview, column oriented encoding and compression can be applied to large amounts of data in various embodiments to compact and simultaneously organize the data to make later scan/search/query operations over the data substantially more efficient. In various embodiments, to begin the encoding and compression, the raw data is initially re-organized as columnized streams of data, and the compaction and scanning process is explained with reference to various non-limiting examples presented below for supplemental context surrounding the lazy cache.

In an exemplary non-limiting embodiment, after columnizing raw data to a set of value sequences, one for each column (e.g., serializing the fields of the columns of data, e.g., all Last Names as one sequence, or all PO Order #s as another sequence, etc.), the data is “integerized” to form integer sequences for each column that are uniformly represented according to dictionary encoding, value encoding, or both dictionary and value encoding, in either order. This integerization stage results in uniformly represented column vectors, and can achieve significant savings by itself, particularly where long fields are recorded in the data, such as text strings. Next, examining all of the columns, a compression stage iteratively applies run length encoding to the run of any of the columns that will lead to the highest amount of overall size savings on the overall set of column vectors.

As mentioned, the packing technique is column based, not only providing superior compression, but also the compression technique itself aids in processing the data quickly once the compacted integer column vectors are delivered to the client side.

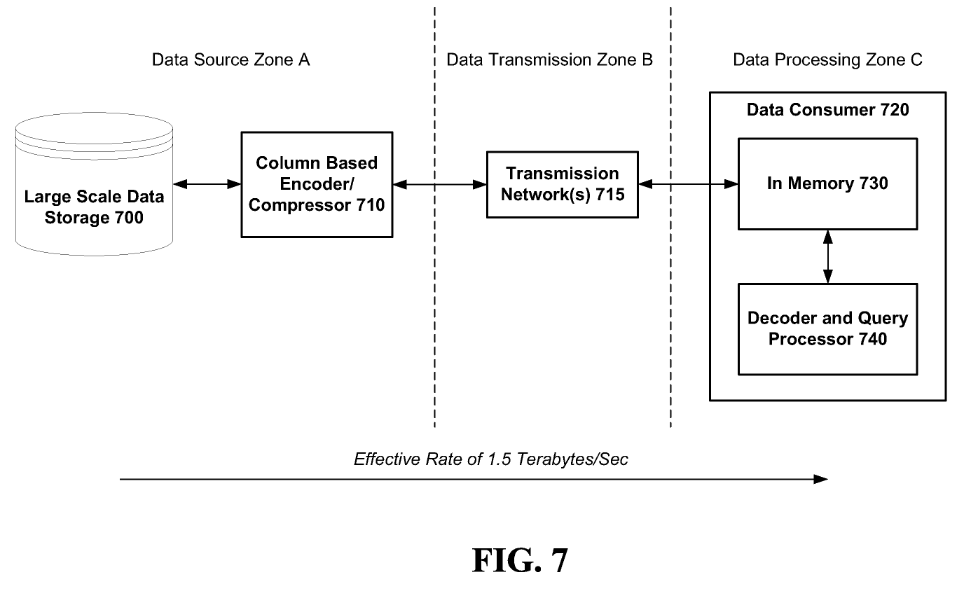

In various non-limiting embodiments, as shown in FIG. 7, a column based encoder/compressor 710 is provided for compacting large scale data storage 700 and for making resulting scan/search/query operations over the data substantially more efficient as well. In response to a query by a data consuming device 720 in data processing zone C, compressor 710 transmits the compressed columns that are pertinent to the query over transmission network(s) 715 of data transmission zone B. The data is delivered to in memory storage 730, and thus decompression of the pertinent columns can be performed very fast by decoder and query processor 740 in data processing zone C. In this regard, a bucket walking is applied to the rows represented by the decompressed columns pertinent to the query for additional layers of efficient processing. Similarity of rows is exploited during bucket walking such that repetitive acts are performed together. As described in more detail below, when the technique is applied to real world sample data, such as large quantities of web traffic data or transaction data, with a standard, or commodity server having 196 Gb RAM, query/scan of server data is achieved at approximately 1.5 Terabytes of data per second, an astronomical leap over the capabilities of conventional systems, and at substantially reduced hardware costs.

While the particular type of data that can be compressed is by no means limited to any particular type of data and the number of scenarios that depend upon large scale scan of enormous amounts of data are similarly limitless, the commercial significance of applying these techniques to business data or records in real-time business intelligence applications cannot be doubted. Real-time reporting and trend identification is taken to a whole new level by the exorbitant gains in query processing speed achieved by the compression techniques.

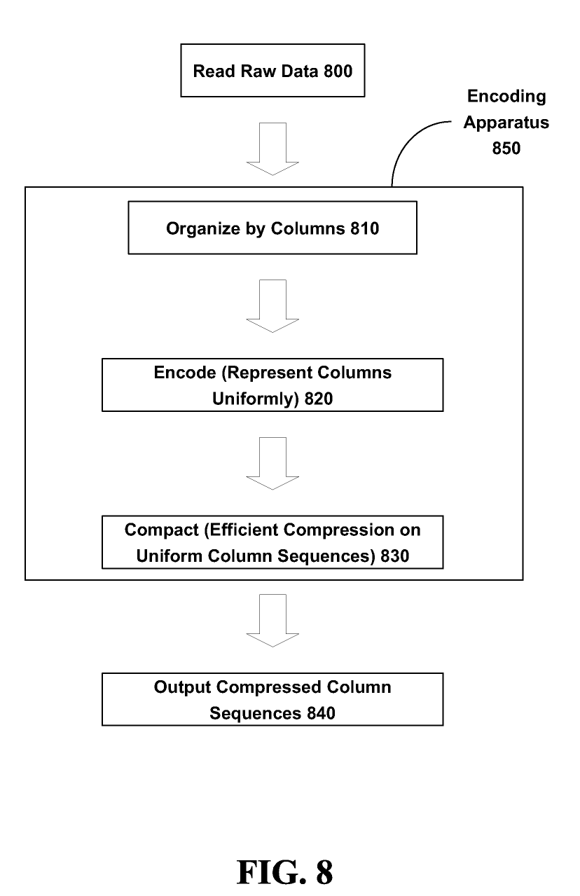

One embodiment of an encoder is generally shown in FIG. 8 in which raw data is received, or read from storage at 800 at which point encoding apparatus and/or encoding software 850 organizes the data as columns at 810. At 820, the column streams are transformed to a uniform vector representation. For instance, integer encoding can be applied to map individual entries like names or places to integers. Such integer encoding technique can be a dictionary encoding technique, which can reduce the data by a factor of 2×-10×. In addition, or alternatively, a value encoding can further provide a 1×-2× reduction in size. This leaves a vector of integers for each column at 820. Such performance increases are sensitive to the data being compacted, and thus such size reduction ranges are given merely as non-limiting estimates to give a general idea of relative performance of the different steps.

Then, at 830, the encoded uniform column vectors can be compacted further. In one embodiment, a run length encoding technique is applied that determines the most frequent value or occurrence of a value across all the columns, in which case a run length is defined for that value, and the process is iterative up to a point where benefits of run length encoding are marginal, e.g., for recurring integer values having at least 64 occurrences in the column.

In another embodiment, the bit savings from applying run length encoding are examined, and at each step of the iterative process, the column of the columns is selected that achieves the maximum bit savings through application of re-ordering and definition of a run length. In other words, since the goal is to represent the columns with as few bits as possible, at each step, the bit savings are maximized at the column providing the greatest savings. In this regard, run length encoding can provide significant compression improvement, e.g., 100× more, by itself.

In another embodiment, a hybrid compression technique is applied at 830 that employs a combination of bit packing and run length encoding. A compression analysis is applied that examines potential savings of the two techniques, and where, for instance, run length encoding is deemed to result in insufficient net bit savings, bit packing is applied to the remaining values of a column vector. Thus, once run length savings are determined to be minimal according to one or more criteria, the algorithm switches to bit packing for the remaining relatively unique values of the column. For instance, where the values represented in a column become relatively unique (where the non-unique or repetitive values are already run length encoded), instead of run length encoding, bit packing can be applied for those values. At 840, the output is a set of compressed column sequences corresponding to the column values as encoded and compressed according to the above-described technique.

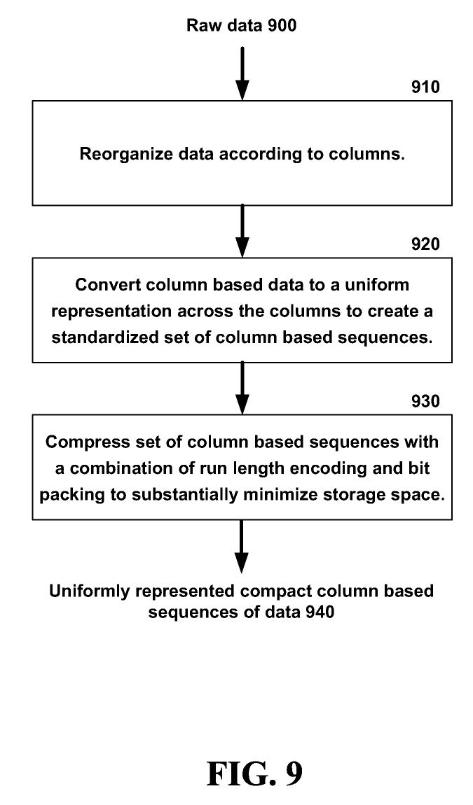

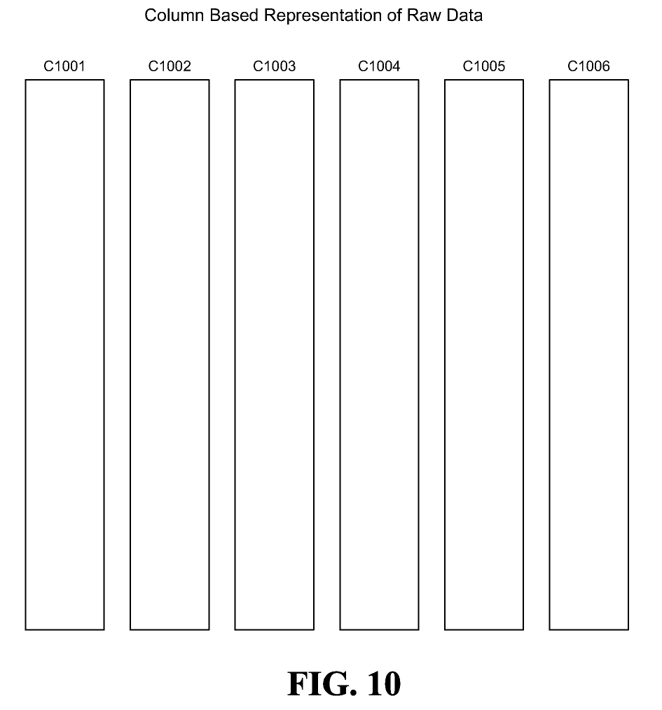

FIG. 9 generally describes the above methodology according to a flow diagram beginning with the input of raw data 900. At 910, as mentioned, the data is reorganized according to the columns of the raw data 900, as opposed to keeping each field of a record together like conventional systems. For instance, as shown in FIG. 10, each column forms an independent sequence, such as sequences C1001, C1002, C1003, C1004, C1005, C1006. Where retail transaction data is the data, for example, column C1001 might be a string of product prices, column C1002 might represent a string of purchase dates, column C1003 might represent a store location, and so on. The column based organization maintains inherent similarity within a data type considering that most real world data collected by computer systems is not very diverse in terms of the values represented. At 920, the column based data undergoes one or more conversions to form uniformly represented column based data sequences.

In one embodiment, step 920 reduces each column to integer sequences of data via dictionary encoding and/or value encoding.

At 930, the column based sequences are compressed with a run length encoding process, and optionally bit packing. In one embodiment, the run-length encoding process re-orders the column data value sequences of the column of all of the columns, which achieves the highest compression savings. Thus, the column where run length encoding achieves the highest savings, is re-ordered to group the common values being replaced by run length encoding, and then a run length is defined for the re-ordered group. In one embodiment, the run length encoding algorithm is applied iteratively across the columns, examining each of the columns at each step to determine the column that will achieve the highest compression savings.

When the benefit of applying run length encoding becomes marginal or minimal according to one or more criterion, such as insufficient bit savings, or savings are less than a threshold, then the benefits of its application correspondingly go down. As a result, the algorithm can stop, or for the remaining values not encoded by run length encoding in each column, bit packing can be applied to further reduce the storage requirements for those values. In combination, the hybrid run length encoding and bit packing technique can be powerful to reduce a column sequence, particularly those with a finite or limited number of values represented in the sequence.

For instance, the field “sex” has only two field values: male and female. With run length encoding, such field could be represented quite simply, as long as the data is encoded according to the column based representation of raw data as described above. This is because the row focused conventional techniques described in the background, in effect, by keeping the fields of each record together, break up the commonality of the column data. “Male” next to an age value such as “21” does not compress as well as a “male” value next to only “male” or “female” values. Thus, the column based organization of data enables efficient compression and the result of the process is a set of distinct, uniformly represented and compacted column based sequences of data 940.

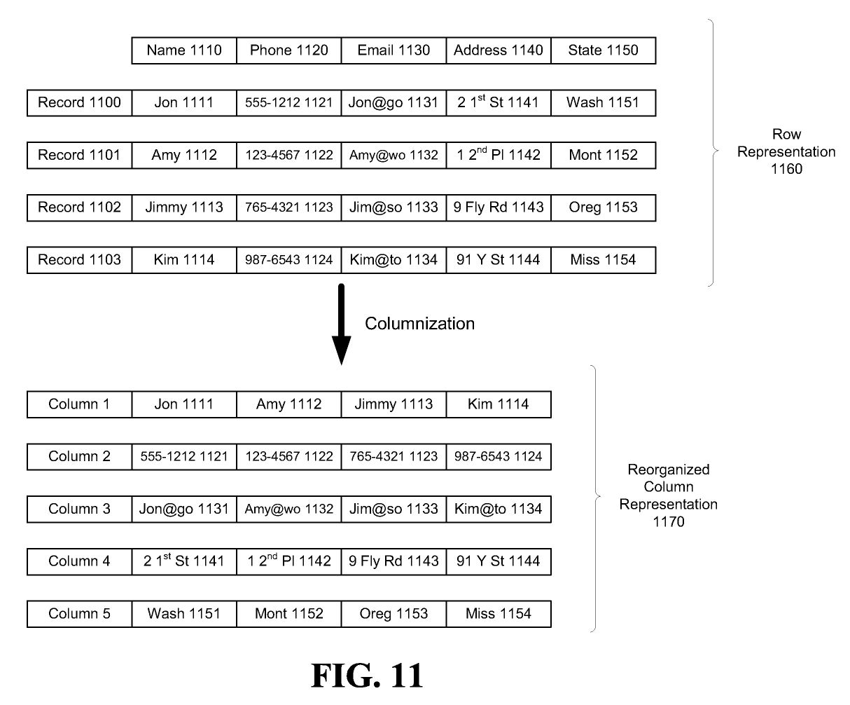

FIG. 11 gives an example of the columnization process based on actual data. The example of FIG. 11 is for 4 data records 1100, 1101, 1102 and 1103, however, this is for simplicity of illustration since the invention can apply to terabytes of data. Generally speaking, when transaction data is recorded by computer systems, it is recorded record-by-record and generally in time order of receiving the records. Thus, the data in effect has rows, which correspond to each record.

In FIG. 11, record 1100 has name field 1110 with value “Jon” 1111, phone field 1120 with value “555-1212” 1121, email field 1130 with value “jon@go” 1131, address field 1140 with value “21^{st} St” 1141 and state field 1150 with value “Wash” 1151.

Record 1101 has name field 1110 with value “Amy” 1112, phone field 1120 with value “123-4567” 1122, email field 1130 with value “Amy@wo” 1132, address field 1140 with value “12^{nd} P1” 1142 and state field 1150 with value “Mont” 1152.

Record 1102 has name field 1110 with value “Jimmy” 1113, phone field 1120 with value “765-4321” 1123, email field 1130 with value “Jim@so” 1133, address field 1140 with value “9 Fly Rd” 1143 and state field 1150 with value “Oreg” 1153.

Record 1103 has name field 1110 with value “Kim” 1114, phone field 1120 with value “987-6543” 1124, email field 1130 with value “Kim@to” 1134, address field 1140 with value “91 Y St” 1144 and state field 1150 with value “Miss” 1154.

When row representation 1160 is columnized to reorganized column representation 1170, instead of having four records each having five fields, five columns are formed corresponding to the fields.

Thus, column 1 corresponds to the name field 1110 with value “Jon” 1111, followed by value “Amy” 1112, followed by value “Jimmy” 1113, followed by value “Kim” 1114. Similarly, column 2 corresponds to the phone field 1120 with value “555-1212” 1121, followed by value “123-4567” 1122, followed by value “765-4321” 1123, followed by value “987-6543” 1124. Column 3 corresponds to the email field 1130 with value “jon@go” 1131, followed by value “Amy@wo” 1132, followed by value “Jim@ so” 1133, followed by value “Kim@to” 1134. In turn, column 4 corresponds to the address field 1140 with value “21^{st} St” 1141, followed by value “12^{nd} P1” 1142, followed by value “9 Fly Rd” 1143, followed by value “91 Y St” 1144. And column 5 corresponds to the state field 1150 with value “Wash” 1151, followed by value “Mont” 1152, followed by value “Oreg” 1153, followed by value “Miss” 1154.

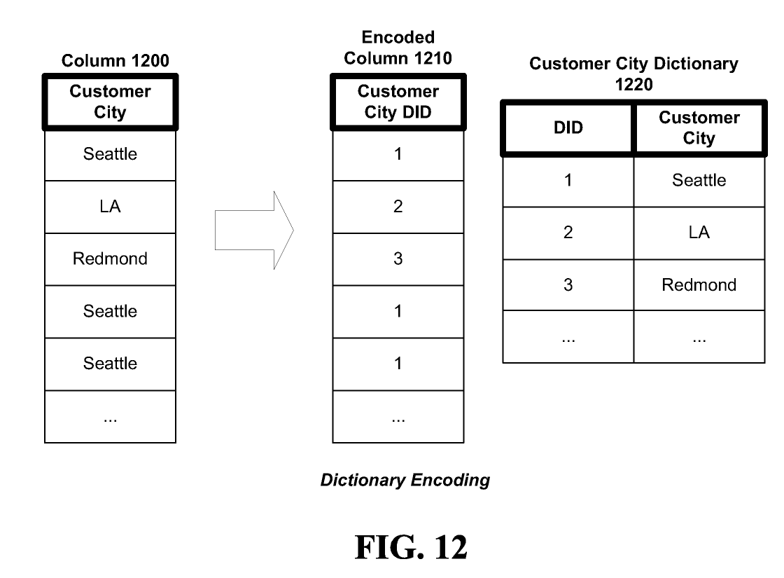

FIG. 12 is a block diagram illustrative of a non-limiting example of dictionary encoding, as employed by embodiments described herein. A typical column 1200 of cities may include values “Seattle,” “Los Angeles,” “Redmond” and so on, and such values may repeat themselves over and over. With dictionary encoding, an encoded column 1210 includes a symbol for each distinct value, such as a unique integer per value. Thus, instead of representing the text “Seattle” many times, the integer “1” is stored, which is much more compact. The values that repeat themselves more often can be enumerated with mappings to the most compact representations (fewest bits, fewest changes in bits, etc.). The value “Seattle” is still included in the encoding as part of a dictionary 1220, but “Seattle” need only be represented once instead of many times. The extra storage implicated by the dictionary 1220 is far outweighed by the storage savings of encoded column 1210.

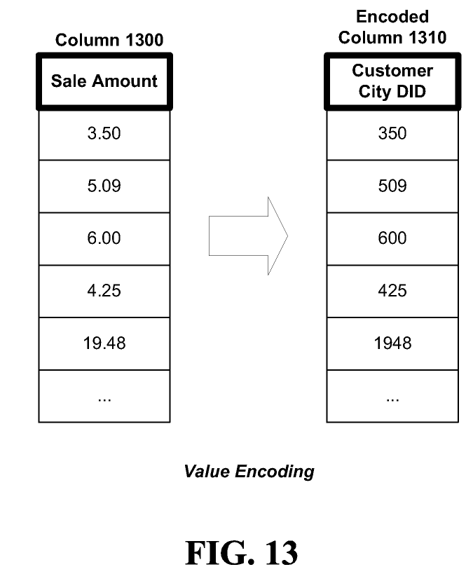

FIG. 13 is a block diagram illustrative of a non-limiting example of value encoding, as employed by embodiments described herein. A column 1300 represents sales amounts and includes a typical dollars and cents representation including a decimal, which implicates float storage. To make the storage more compact, a column 1310 encoded with value encoding may have applied to it a factor of 10, e.g., 10², in order to represent the values with integers instead of float values, with integers requiring fewer bits to store. The transformation can similarly be applied in reduce the number of integers representing a value. For instance, values consistently ending in the millions for a column, such as 2,000,000, 185,000,000, etc. can all be divided by 10⁶ to reduce the values to more compact representations 2, 185, etc.

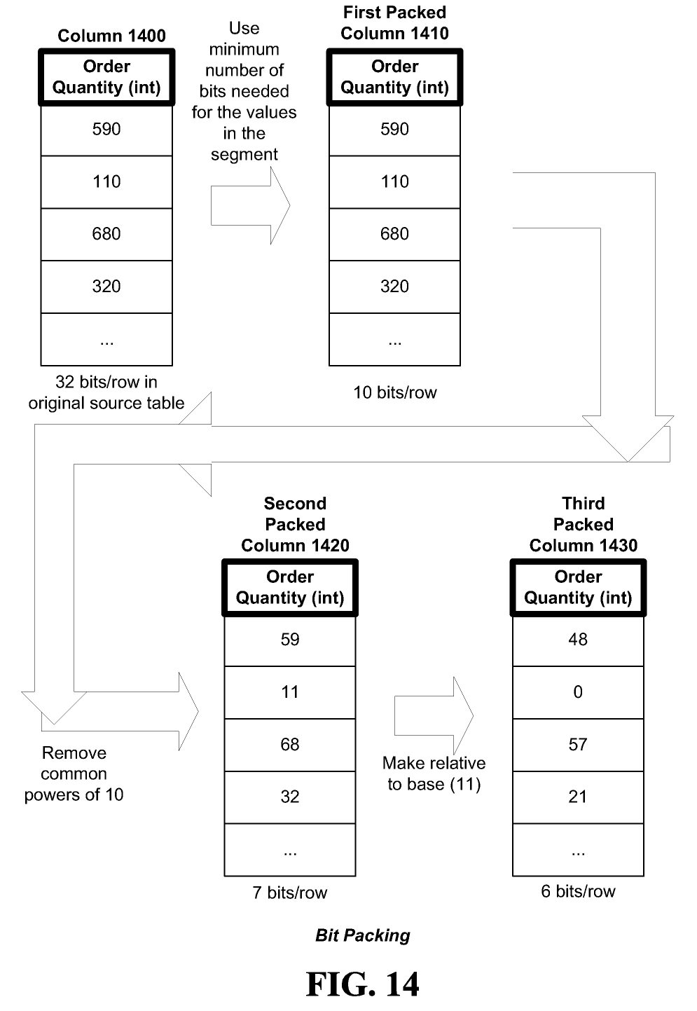

FIG. 14 is a block diagram illustrative of a non-limiting example of bit packing, as employed by embodiments described herein. A column 1400 represents order quantities as integerized by dictionary and/or value encoding, however, 32 bits per row are reserved to represent the values. Bit packing endeavors to use the minimum number of bits for the values in the segment. In this example, 10 bits/row can be used to represent the values 590, 110, 680 and 320, representing a substantial savings for the first layer of bit packing applied to form column 1410.

Bit packing can also remove common powers of 10 (or other number) to form a second packed column 1420. Thus, if the values end in 0 as in the example, that means that the 3 bits/row used to represent the order quantities are not needed reducing the storage structure to 7 bits/row. Similar to the dictionary encoding, any increased storage due to the metadata needed to restore the data to column 1400, such as what power of 10 was used, is vastly outweighed by the bit savings.

As another layer of bit packing to form third packed column 1430, it can be recognized that it takes 7 bits/row to represent a value like 68, but since the lowest value is 11, the range can be shifted by 11 (subtract each value by 11), and then the highest number is 68−11=57, which can be represented with just 6 bits/row since 2⁶=64 value possibilities. While FIG. 14 represents a particular order of packing layers, the layers can be performed in different orders, or alternatively, the packing layers can be selectively removed or supplemented with other known bit packing techniques.

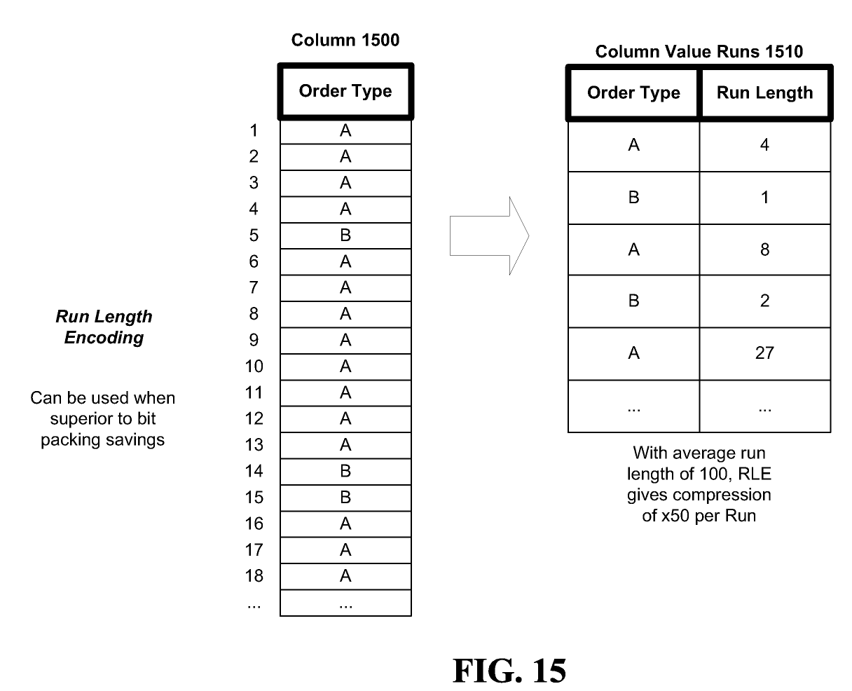

FIG. 15 is a block diagram illustrative of a non-limiting example of run length encoding, as employed by embodiments described herein. As illustrated, a column such as column 1500 representing order types can be encoded effectively with run length encoding due to the repetition of values. A column value runs table 1510 maps order type to a run length for the order type. While slight variations on the representation of the metadata of table 1510 are permitted, the basic idea is that run length encoding can give compression of ×50 for a run length of 100, which is superior to the gains bit packing can generally provide for the same data set.

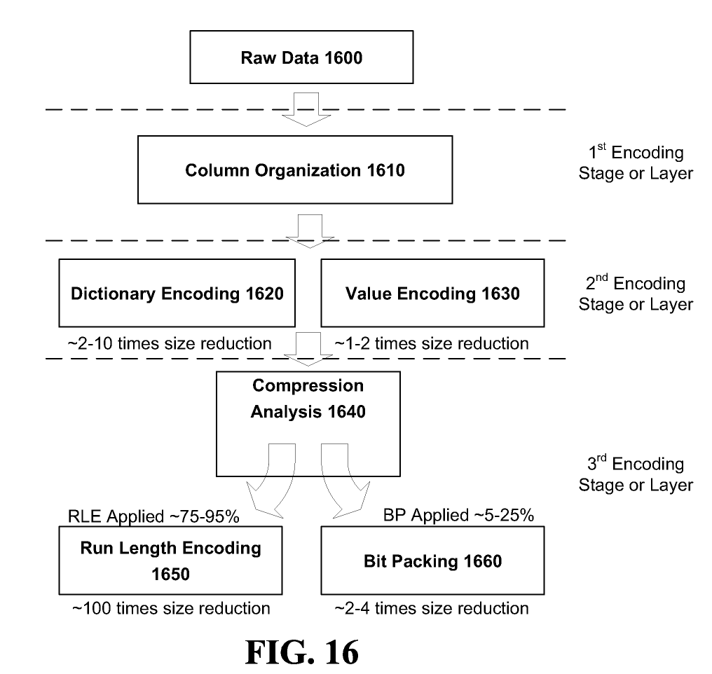

FIG. 16 is a general block diagram of an embodiment provided herein in which the techniques of FIGS. 7-10 are synthesized into various embodiments of a unified encoding and compression scheme. Raw data 1600 is organized as column streams according to column organization 1610. Dictionary encoding 1620 and/or value encoding 1630 provide respective size reductions as described above. Then, in a hybrid RLE and bit packing stage, a compression analysis 1640 examines potential bit savings across the columns when determining whether to apply run length encoding 1650 or bit packing 1660.

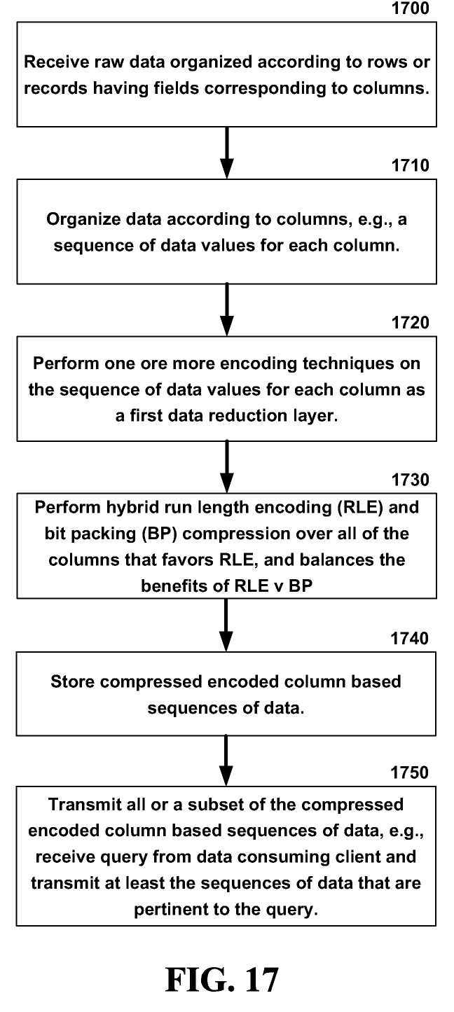

FIG. 16 is expanded upon in the flow diagram of FIG. 17. At 1700, raw data is received according to an inherent row representation. At 1710, the data is re-organized as columns. At 1720, dictionary and/or value encoding are applied to reduce the data a first time. At 1730, a hybrid RLE and bit packing technique, as described above, can be applied. At 1740, the compressed and encoded column based sequence of data are stored. Then, when a client queries for all or a subset of the compressed encoded column based sequences of data, the affected columns are transmitted to the requesting client at 1750.

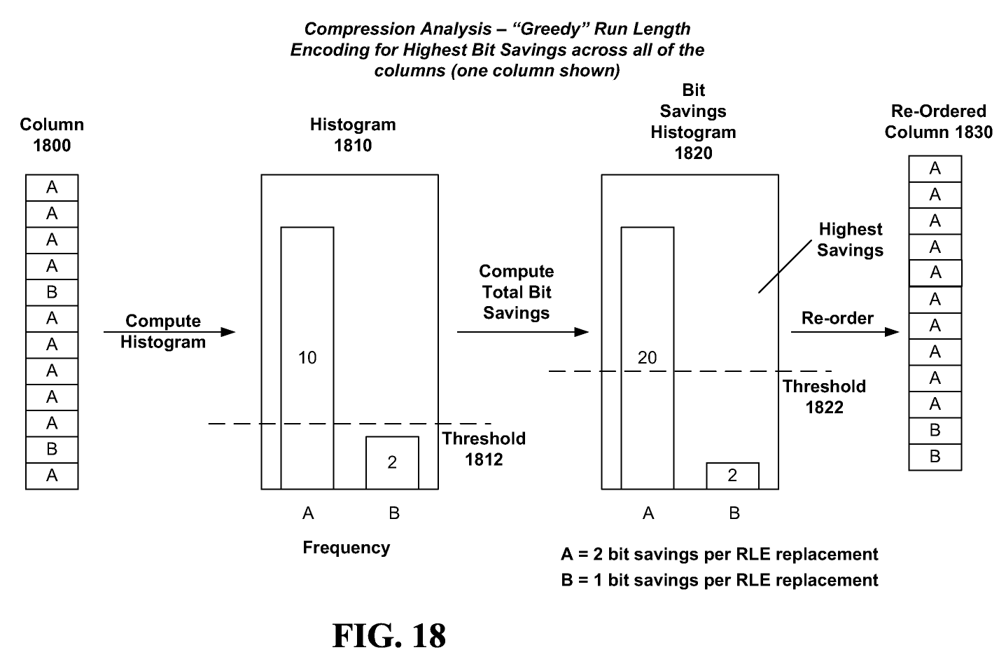

FIG. 18 is a block diagram of an exemplary way to perform the compression analysis of the hybrid compression technique. For instance, a histogram 1810 is computed from column 1800, which represents the frequency of occurrences of values, or the frequency of occurrences of individual run lengths. Optionally, a threshold 1812 can be set so that run length encoding does not apply for reoccurrences of a value that are small in number where run length gains may be minimal. Alternatively, or in addition, a bit savings histogram 1820 represents not only frequency of occurrences of values, but also the total bit savings that would be achieved by applying one or the other of the compression techniques of the hybrid compression model. In addition, a threshold 1822 can again be optionally applied to draw the line where run length encoding benefits are not significant enough to apply the technique. Instead, bit packing can be applied for those values of the column.

In addition, optionally, prior to applying run length encoding of the column 1800, the column 1800 can be re-ordered to group all of the most similar values as re-ordered column 1830. In this example, this means grouping the As together for a run length encoding and leaving the Bs for bit packing since neither the frequency nor the total bit savings justify run length encoding for the 2 B values. In this regard, the re-ordering can be applied to the other columns to keep the record data in lock step, or it can be remembered via column specific metadata how to undo the re-ordering of the run length encoding.

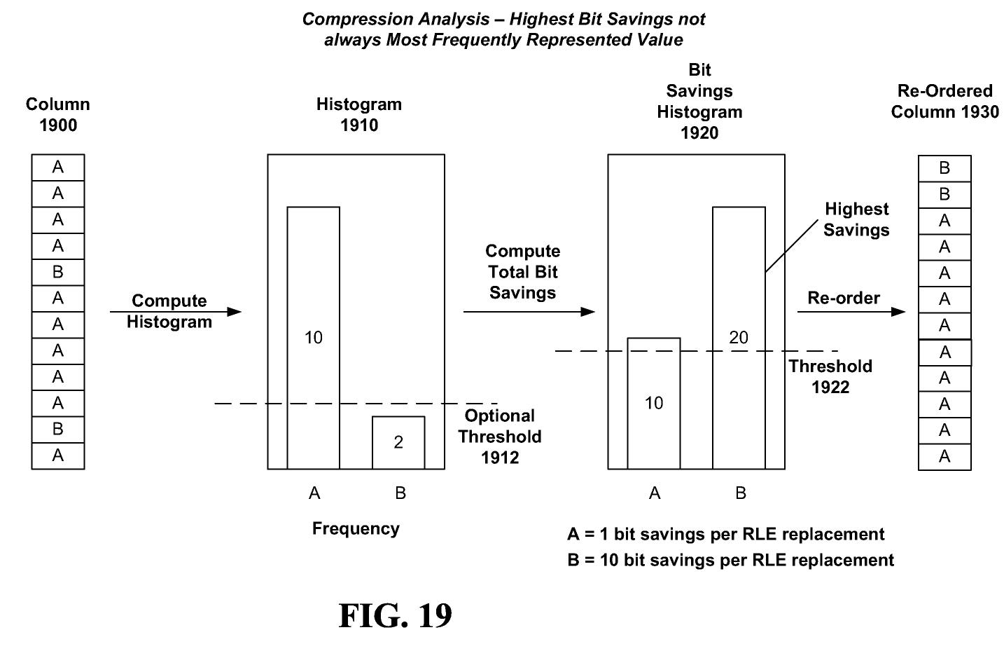

FIG. 19 illustrates a similar example where the compression analysis is applied to a similar column 1900, but where the bit savings per replacement of a run length have been altered so that now, it is justified according to the hybrid compression analysis to perform the run length encoding for the 2 B values, even before the 10 A values, since the 2 B values result in higher net bit savings. In this respect, much like a glutton choosing among 10 different plates with varying foods on them, application of run length encoding is “greedy” in that it iteratively seeks the highest gains in size reduction across all of the columns at each step. Similar to FIG. 13, a histogram of frequencies 1910 and/or a bit savings histogram 1920 data structure can be built to make determinations about whether to apply run length encoding, as described, or bit packing. Also, optional thresholds 1912 and 1922 can be used when deciding whether to pursue RLE or bit packing. Re-ordered column 1930 can help the run length encoding to define longer run lengths and thus achieve greater run length savings.

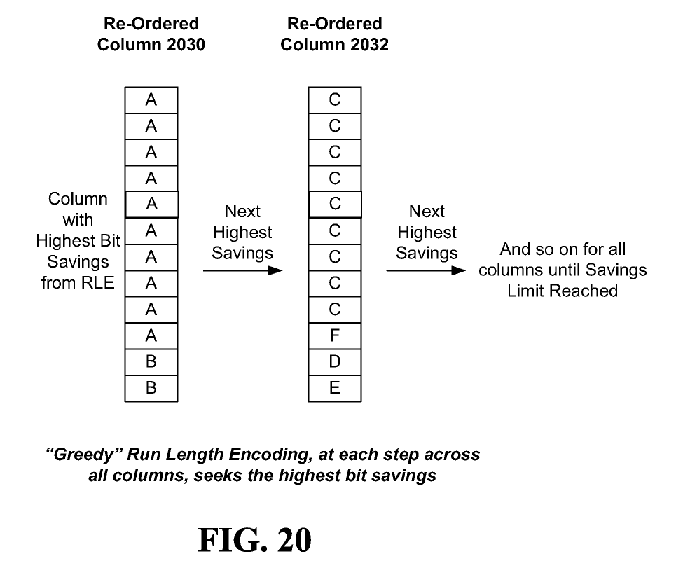

FIG. 20 illustrates the “greedy” aspect of the run length encoding that examines, across all of the columns, where the highest bit savings are achieved at each step, and can optionally include re-ordering the columns as columns 2030, 2032, etc. to maximize run length savings. At a certain point, it may be that run length savings are relatively insignificant because the values are relatively unique at which point run length encoding is stopped.

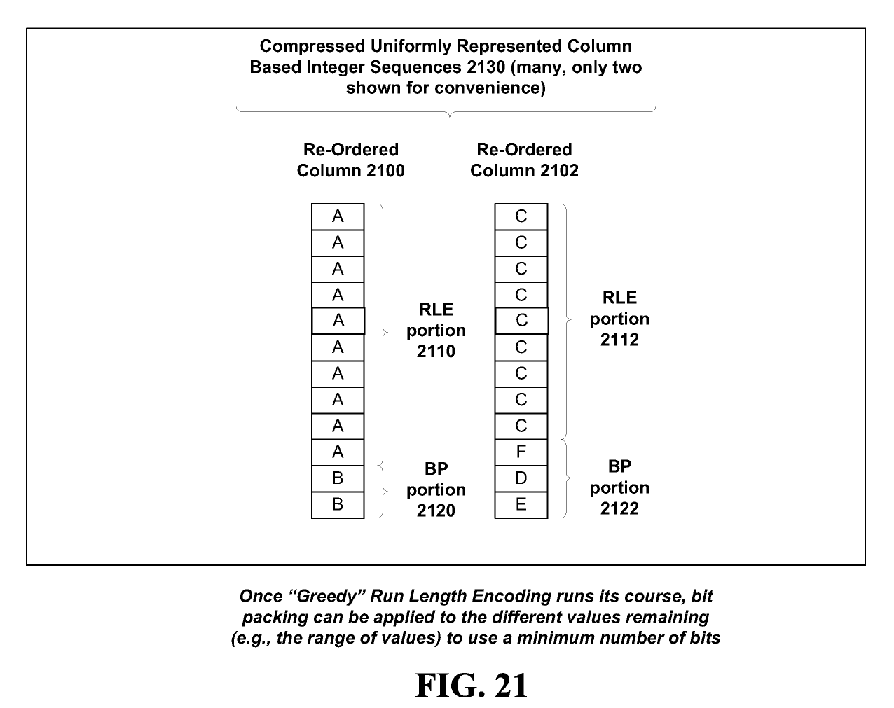

In the hybrid embodiment, bit packing is applied to the range of remaining values, which is illustrated in FIG. 21. In this regard, applying the hybrid compression technique, re-ordered column 2100 includes an RLE portion 2110 and a bit packing portion 2120 generally corresponding to recurring values and relatively unique values, respectively. Similarly, re-ordered column 2102 includes RLE portion 2112 and BP portion 2122.

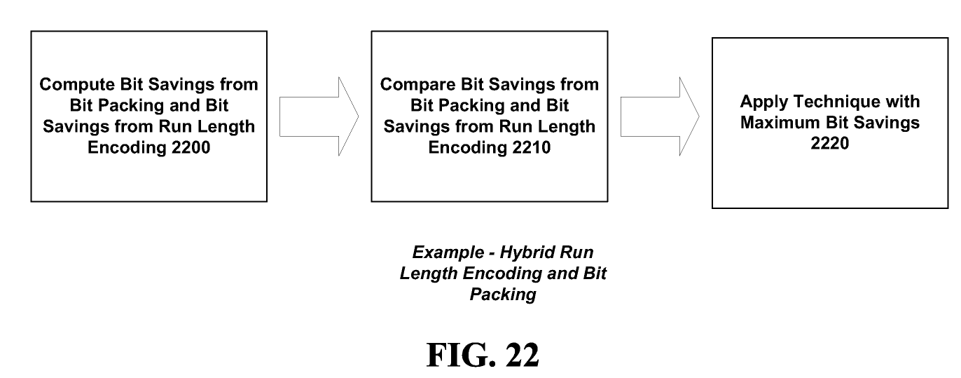

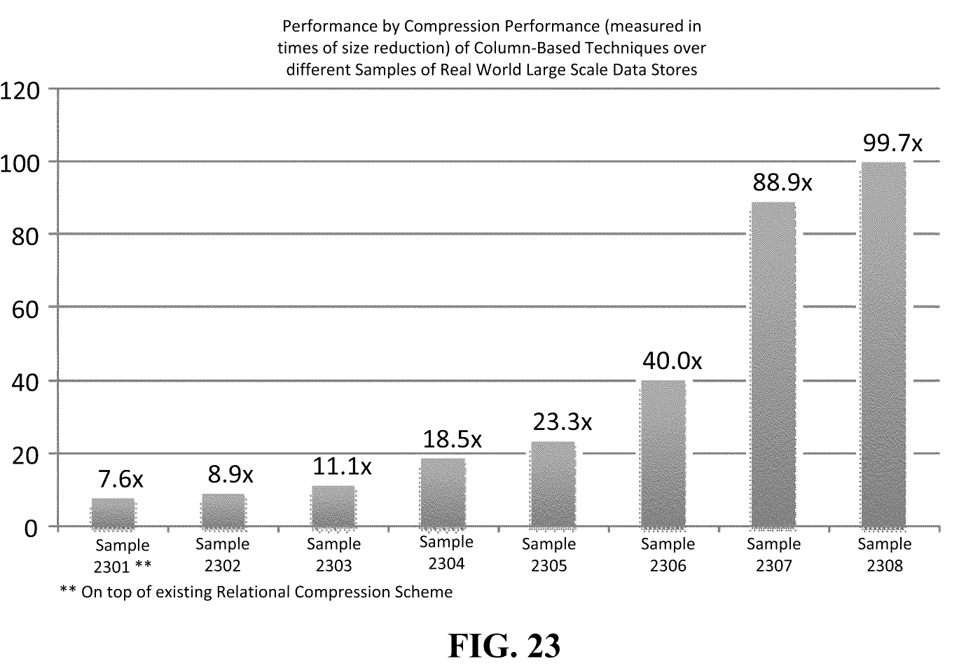

In one embodiment shown in FIG. 22, the hybrid algorithm computes the bit savings from bit packing and bit savings from run length encoding 2200, and then the bit savings from bit packing and bit savings from run length are compared at 2210 or examined to determine which compression technique maximizes bit savings at 2220.

Exemplary performance of the above-described encoding and compression techniques illustrates the significant gains that can be achieved on real world data samples 2301, 2302, 2303, 2304, 2305, 2306, 2306, 2307 and 2308, ranging in performance improvement from about 9× to 99.7×, which depends on, among other things, the relative amounts of repetition of values in the particular large scale data sample.

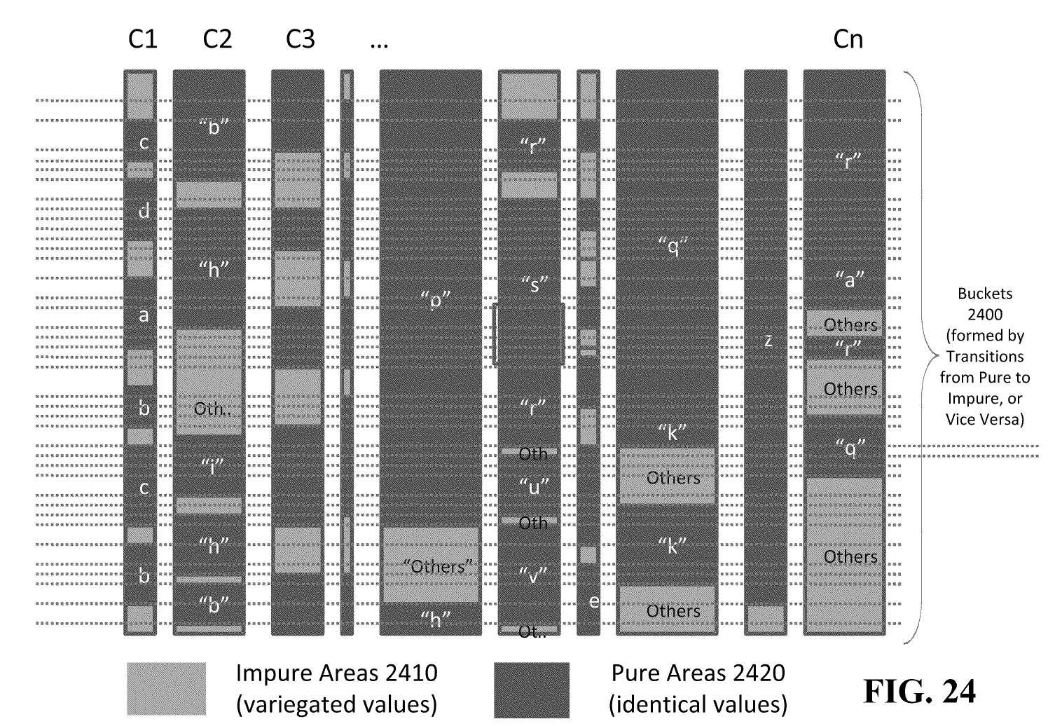

FIG. 24 is a block diagram showing the final result of the columnization, encoding and compression processes described herein in various embodiments. In this regard, each column C1, C2, C3, . . . , CN includes areas having homogeneous repeated values to which run length encoding has been applied, and other areas labeled “Others” or “Oth” in the diagram, which represent groups of heterogeneous values in the column. The areas with identical repeated values defined by run length are the pure areas 2420 and the areas having the variegated values are the impure areas 2410, as indicated in the legend. In this respect, as one's eye “walks down” the columns, a new view over the data emerges as an inherent benefit of the compression techniques discussed herein.

Across all of the columns, at the first transition point between an impure area 2410 and a pure area 2420, or the other way around, a bucket is defined as the rows from the first row to the row at the transition point. In this regard, buckets 2400 are defined down the columns at every transition point as shown by the dotted lines. Buckets 2400 are defined by the rows between the transitions.

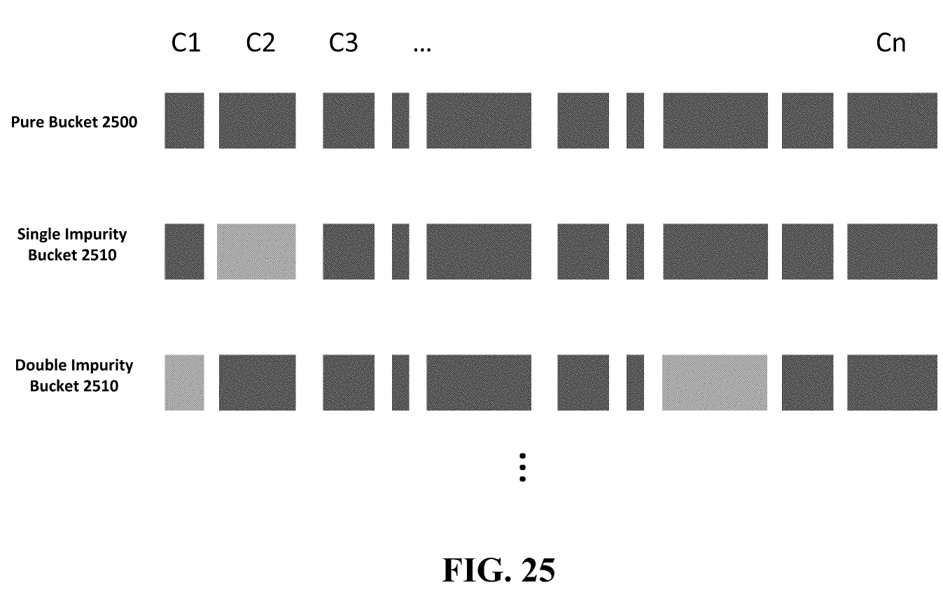

FIG. 25 shows a nomenclature that is defined for the buckets based on the number of pure and impure areas across a particular row. A pure bucket 2500 is one with no impure areas. A single impurity bucket 2510 is one with 1 impure area across the rows of the bucket. A double impurity bucket 2510 is one with 2 impure area across the rows of the bucket. A triple impurity bucket has 3, and so on.

Thus, during an exemplary data load process, data is encoded, compressed and stored in a representation suitable for efficient querying later and a compression technique can be that used that looks for data distribution within a segment, and attempts to use RLE compression more often than bit packing. In this regard, RLE provides the following advantages for both compression and querying: (A) RLE typically requires significantly less storage than bit packing and (B) RLE includes the ability to effectively “fast forward” through ranges of data while performing such query building block operations as Group By, Filtering and/or Aggregations; such operations can be mathematically reduced to efficient operations over the data organized as columns.

In various non-limiting embodiments, instead of sorting one column segment at a time before sorting another column in the same segment, the compression algorithm clusters rows of data based on their distribution, and as such increases the use of RLE within a segment. Where used herein, the term “bucket” is used to describe clusters of rows, which, for the avoidance of doubt, should be considered distinct from the term “partition,” a well defined online analytical processing (OLAP) and RDBMS concept.

The above discussed techniques are effective due to the recognition that data distribution is skewed, and that in large amounts of data, uniform distributions rarely exist. In compression parlance, Arithmetic Coding leverages this: by representing frequently used characters using fewer bits and infrequently used characters using more bits, with the goal of using fewer bits in total.

With bit packing, a fixed-sized data representation is utilized for faster random access. However, the compression techniques described herein also have the ability to use RLE, which provides a way to use fewer bits for more frequent values. For example, if an original table (including one column Col1 for simplicity of illustration) appeared as follows:

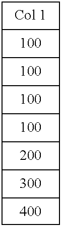

Then, after compression, Col1 appears as follows, divided into a first portion to which run length encoding is applied and a second portion to which bit packing applies:

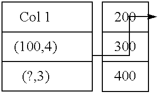

As can be seen above, occurrences of the most common value, 100, is collapsed into RLE, while the infrequently appearing values are still stored in a fixed-width, bit packed storage.

In this regard, the above-described embodiments of data packing includes two distinct phases: (1) Data analysis to determine bucketization, and (2) Reorganization of segment data to conform to the bucketized layout. Each of these are described in exemplary further detail below.

With respect to data analysis to determine bucketization, a goal is to cover as much data within a segment with RLE as possible. As such, this process is skewed towards favoring “thicker” columns, i.e., columns that have large cardinality, rather than columns that will be used more frequently during querying. Usage based optimizations can also be applied.

For another simple example, for the sake of illustration, the following small table is used. In reality, such small tables are not generally included within the scope of the above described compression because the benefit of compression of such tables tends not to be worthwhile. Also, such small tables are not generally included since compression occurs after encoding is performed, and works with data identifications (IDs) in one embodiment, not the values themselves. Thus, a Row # column is also added for illustration.

| | Col1 | Col2 |
|---|---|---|
| Row # | (9 bits per value) | (11 bits per value) |
| 1 | 100 | 1231 |
| 2 | 100 | 12 |
| 3 | 200 | 1231 |
| 4 | 100 | 32 |
| 5 | 400 | 1231 |
| 6 | 100 | 111 |
| 7 | 100 | 12 |

Across the columns, the bucketization process begins by finding the single value the takes the most space in the segment data. As mentioned above in connection with FIGS. 18 and 19, this can be done using simple histogram statistics for each column, e.g., as follows.

| | Most | | |
|---|---|---|---|
| Column | Common Value | # occurrences | Space Saved |
| Col1 | 100 | 5 | 45 bits |
| Col2 | 1231 | 3 | 33 bits |

Once this value is selected, rows in the segment are logically reordered such that all occurrences of this value occur in a sequence, to maximize the length of an RLE run:

| Original | | |
|---|---|---|
| Row # | Col1 | Col2 |
| 1 | 100 | 1231 |
| 2 | | 12 |
| 4 | | 32 |
| 6 | | 111 |
| 7 | | 12 |
| 3 | 200 | 1231 |
| 5 | 400 | 1231 |

In one embodiment, all values belonging to the same row exist at the same index in each of the column segment, e.g., col1[3] and col2[3] both belong to the third row. Ensuring this provides efficient random access to values in the same row, instead of incurring the cost of an indirection through a mapping table for each access. Therefore, in the presently described embodiment of the application of the greedy RLE algorithm, or the hybrid RLE and bit packing algorithm, when reordering a value in one column, this implies values in other column segments are reordered as well.

In the example above, two buckets now exist: {1,2,4,6,7} and {3,5}. As mentioned, the RLE applied herein is a greedy algorithm, which means that the algorithm follows the problem solving metaheuristic of making the locally optimum choice at each stage with the hope of finding the global optimum. After the first phase of finding the largest bucket, the next phase is to select the next largest bucket and repeat the process within that bucket.

| Original | | |
|---|---|---|
| Row # | Col1 | Col2 |
| 2 | 100 | 12 |
| 7 | | |
| 1 | | 1231 |
| 4 | | 32 |
| 6 | | 111 |
| 3 | 200 | 1231 |
| 5 | 400 | 1231 |

Now, there are three buckets: {2,7}, {1,4,6}, {3,5}, when the rows are re-organized accordingly. The largest bucket is the second one, but there are no repeating values there. The first bucket has all columns with RLE runs, and the rest of the values are unique, so it is known that there are no further RLE gains to be had in Col1. Taking the {3,5} bucket into account, there is another value, 1231, that can be converted to RLE. Interestingly, 1231 also appears on the previous bucket, and that bucket can be reordered such that 1231 is at the bottom, ready to be merged with the top of the next bucket. The next step results in the following:

| Original | | |
|---|---|---|
| Row # | Col1 | Col2 |
| 2 | 100 | 12 |
| 7 | | |
| 6 | | 111 |
| 4 | | 32 |
| 1 | | 1231 |
| 3 | 200 | |
| 5 | 400 | |

In the example above, four buckets now exist: {2,7}, {6,4}, {1}, {3,5}. Unable to reduce further the data further, the process moves to the next phase of reorganization of segment data.

While the illustration at the top reordered the rows as well, for performance reasons, the determination of the buckets can be based purely on statistics, from the act of reordering data within each column segment. The act of reordering data within each column segment can be parallelized based on available cores using a job scheduler.

As mentioned, the use of the above-described techniques is not practical for small datasets. For customer datasets, the above-described techniques frequently undergoes tens of thousands of steps, which can take time. Due to the greedy nature of the algorithm, the majority of space savings occur in the first few steps. In the first couple of thousand steps, most of the space that will be saved has already been saved. However, as will be observed on the scanning side of the compressed data, the existence of RLE in the packed columns gives significant performance boosts during querying, since even tiny compression gains reap rewards during querying.

Since one segment is processed at a time, multiple cores can be used, overlapping the time taken to read data from the data source into a segment with the time taken to compress the previous segment. With conventional technologies, at the rate of ˜100K rows/sec reading from a relational database, a segment of 8M rows will take ˜80 seconds, which is a significant amount of time available for such work. Optionally, in one embodiment, packing of the previous segment may also be stopped once data for the next segment is available.

### Processing of the Column Based Data Encodings

As mentioned, the way that the data is organized according to the various embodiments for column based encoding lends itself to an efficient scan at the consuming side of the data, where the processing can be performed very fast on a select number of the columns in memory. The above-described data packing and compression techniques update the compression phase during row encoding, while scanning includes a query optimizer and processor to leverage the intelligent encoding.

The scan or query mechanism can be used to efficiently return results to business intelligence (BI) queries and is designed for the clustered layout produced by the above-described data packing and compression techniques, and optimizes for increased RLE usage, e.g., it is expected that during query processing, a significant number of columns used for querying would have been compressed using RLE. In addition, the fast scanning process introduces a column-oriented query engine, instead of a row-wise query processor over column stores. As such, even in buckets that contain bit pack data (as opposed to RLE data), the performance gains due to data locality can be significant.

In addition to introducing the above-described data packing and compression techniques and the efficient scanning, the following can be supported in a highly efficient manner: “OR” slices in queries and “Joins” between multiple tables where relationships have been specified.

As alluded to above, the scanning mechanism assumes segments contain buckets that span across a segment, and contains columns values in “pure” RLE runs or “impure” others bit pack storage, such as shown in FIG. 24.

In one embodiment, the scanning is invoked on a segment, the key being to work one bucket at a time. Within a bucket, the scanning process performs column-oriented processing in phases, depending on the query specification. The first phase is to gather statistics about what column areas are Pure, and what areas are Impure. Next, filters can be processed followed by processing of Group By operations, followed by processing of proxy columns. Next, aggregations can be processed as another phase.

As mentioned earlier, it is noted that the embodiments presented herein for the scanning implement column-oriented query processing, instead of row-oriented like conventional systems. Thus, for each of these phases, the actual code executed can be specific to: (1) whether the column being operated on is run length encoded or not, (2) the compression type used for bit packing, (3) whether results will be sparse or dense, etc. For Aggregations, additional considerations are taken into account: (1) encoding type (hash or value), (2) aggregation function (sum/min/max/count), etc.

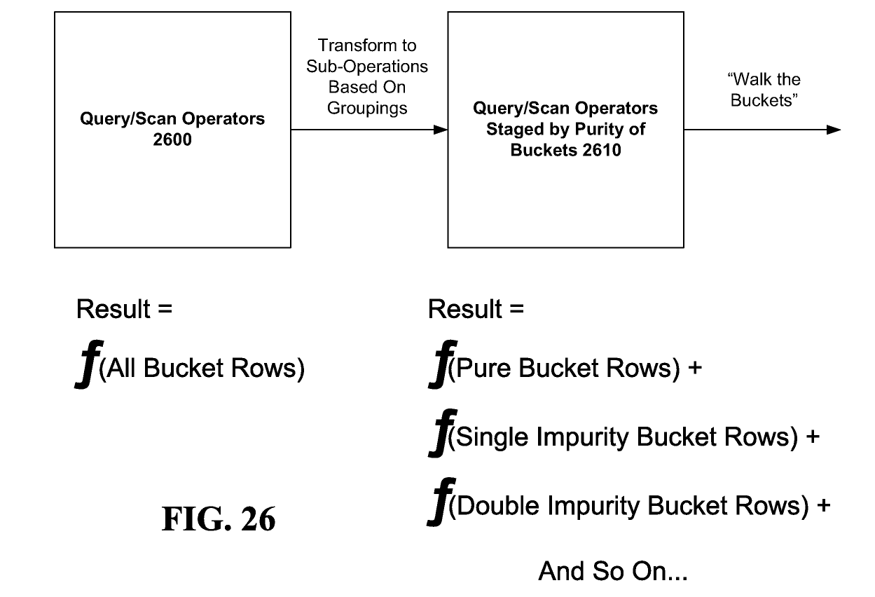

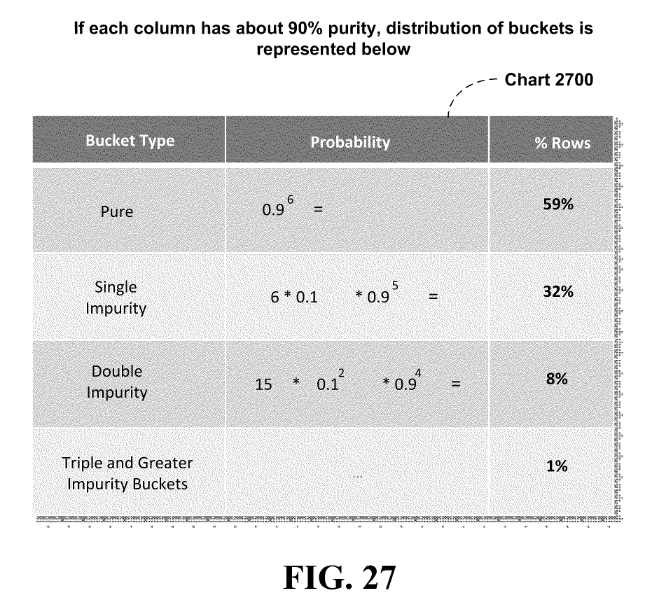

In general, the scanning process thus follows the form of FIG. 26 in which a query result from various standard query/scan operators 2600 is a function of all of the bucket rows. The query/scan operators 2600 can be broken up mathematically in effect such that the filters, Group Bys, proxy columns, and aggregations are processed separate from one another in phases.

In this regard, for each of the processing steps, the operators are processed according to different purities of the buckets at 2610 according to a bucket walking process. Consequently, instead of a generalized and expensive scan of all the bucket rows, with the specialization of different buckets introduced by the work of the encoding and compression algorithms described herein, the result is thus an aggregated result of the processing of pure buckets, single impurity buckets, double impurity buckets, etc.

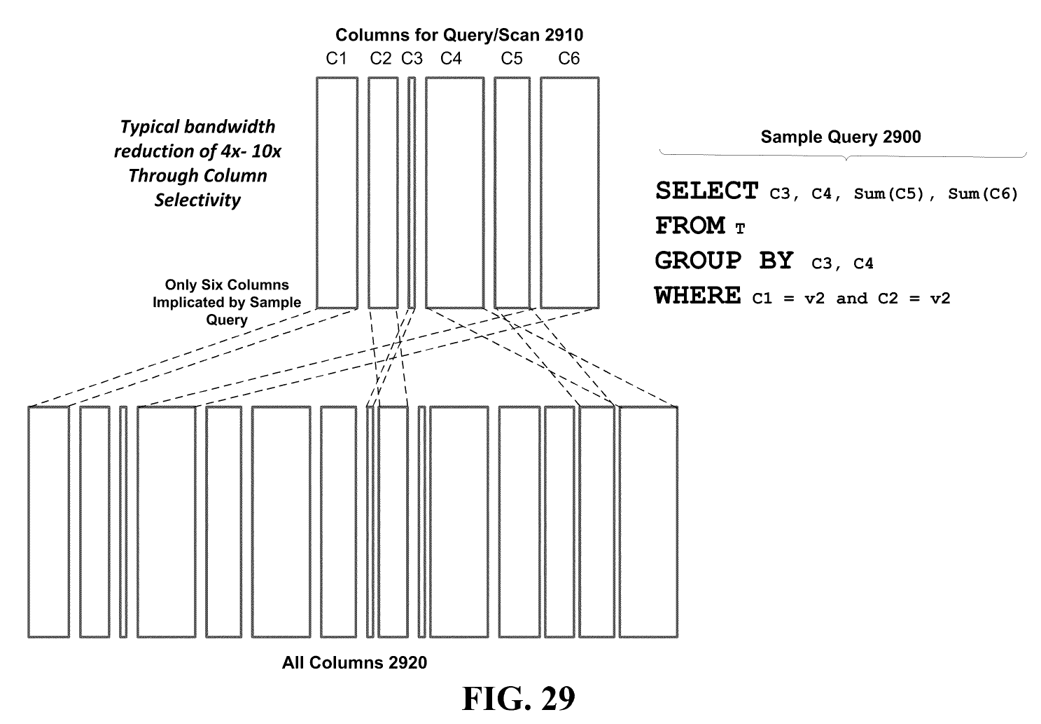

FIG. 24 shows a sample distribution of buckets and the power of the compression architecture, since processing performed over pure buckets is the fastest due to the reduction of processing mathematics to simple operations, followed by the second fastest being the single impurity buckets, and so on for additional impurity buckets. Moreover, it has been found that a surprisingly large number of buckets are pure. For instance, as shown in FIG. 29, for six columns implicated by a query, if each column has about 90% purity (meaning about 90% of the values are represented with run length encoding due to similar data), then about 60% of the buckets will be pure, about ⅓ will be single impurity, about 8% will be double purity, and the rest will be accounted for at a mere 1%. Since processing of pure buckets is the fastest, and processing of single impurity and double impurity buckets is still quite fast, the “more complex” processing of buckets with 3 or more impure areas is kept to a minimum.

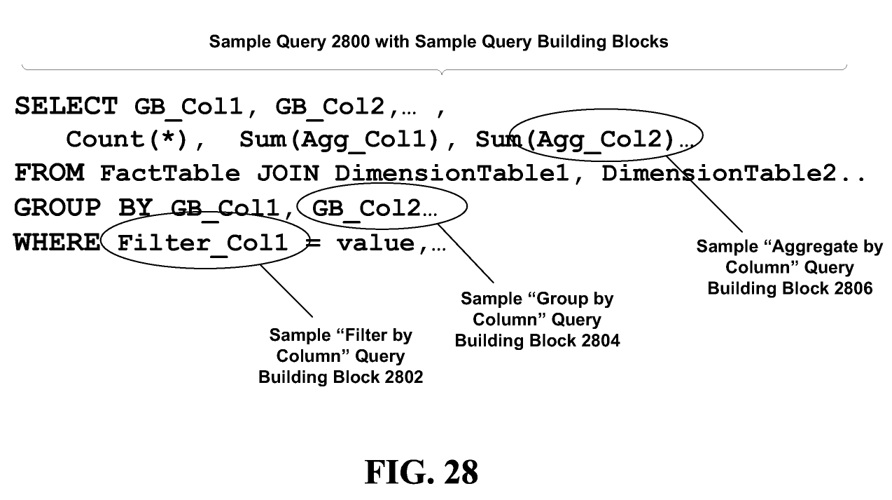

FIG. 28 indicates a sample query 2800 with some sample standard query building blocks, such as sample “filter by column” query building block 2802, sample “Group by Column” query building block 2804 and sample “Aggregate by Column” query building block 2806.

FIG. 29 is a block diagram illustrating an additional aspect of bandwidth reduction through column selectivity. Reviewing sample query 2900, one can see that no more than 6 columns 2910 of all columns 2920 are implicated, and thus only six columns need be loaded into local RAM for a highly efficient query.

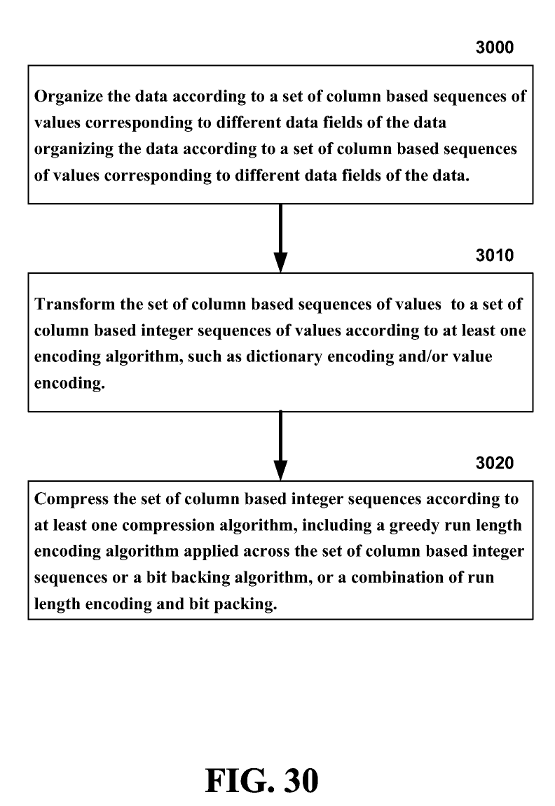

Various embodiments have thus been described herein. FIG. 30 illustrates an embodiment for encoding data, including organizing the data according to a set of column based sequences of values corresponding to different data fields of the data at 3000. Then, at 3010, the set of column based sequences of values are transformed to a set of column based integer sequences of values according to at least one encoding algorithm, such as dictionary encoding and/or value encoding. Then, at 3020, the set of column based integer sequences are compressed according to at least one compression algorithm, including a greedy run length encoding algorithm applied across the set of column based integer sequences or a bit backing algorithm, or a combination of run length encoding and bit packing.

In one embodiment, the integer sequences are analyzed to determine whether to apply run length encoding (RLE) compression or bit packing compression including analyzing bit savings of RLE compression relative to bit packing compression to determine where the maximum bit savings is achieved. The process can include generating a histogram to assist in determining where the maximum bit savings are achieved.

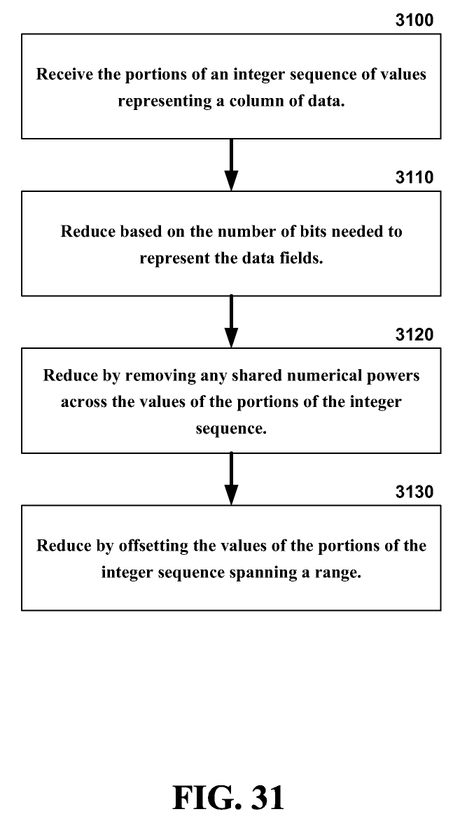

In another embodiment, as shown in FIG. 31, a bit packing technique includes receiving, at 3100, the portions of an integer sequence of values representing a column of data, and three stages of potential reduction by bit packing. At 3110, the data can be reduced based on the number of bits needed to represent the data fields. At 3120, the data can be reduced by removing any shared numerical powers across the values of the portions of the integer sequence. At 3130, the data can also be reduced by offsetting the values of the portions of the integer sequence spanning a range.

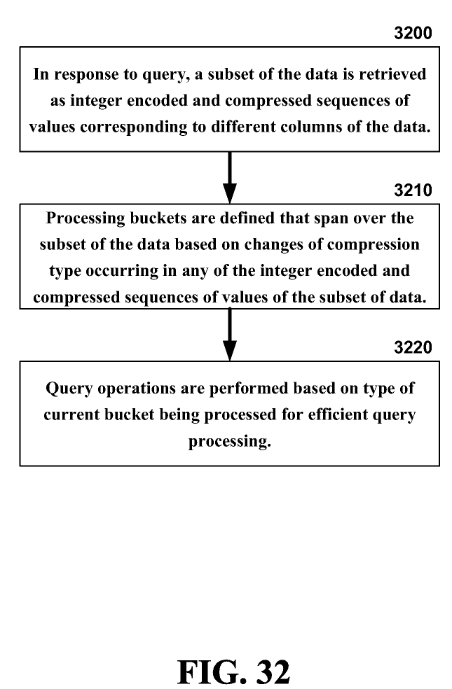

In another embodiment, as shown in the flow diagram of FIG. 32, in response to a query, at 3200, a subset of the data is retrieved as integer encoded and compressed sequences of values corresponding to different columns of the data. Then, at 3210, processing buckets are defined that span over the subset of the data based on changes of compression type occurring in any of the integer encoded and compressed sequences of values of the subset of data. Next, at 3220, query operations are performed based on type of current bucket being processed for efficient query processing. The operations can be performed in memory, and parallelized in a multi-core architecture.

Different buckets include where (1) the different portions of values in the bucket across the sequences are all compressed according to run length encoding compression, defining a pure bucket, (2) all but one portion compressed according to run length encoding, defining a single impurity bucket, or (3) all but two portions compressed according to run length encoding, defining a double impurity bucket.

The improved scanning enables performing a variety of standard query and scan operators much more efficiently, particularly for the purest buckets. For instance, logical OR query slice operations, query join operations between multiple tables where relationships have been specified, filter operations, Group By operations, proxy column operations or aggregation operations can all be performed more efficiently when the bucket walking technique is applied and processing is performed based on bucket type.

### Exemplary Networked and Distributed Environments

One of ordinary skill in the art can appreciate that the various embodiments of column based encoding and query processing described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may cooperate to perform one or more aspects of any of the various embodiments of the subject disclosure.

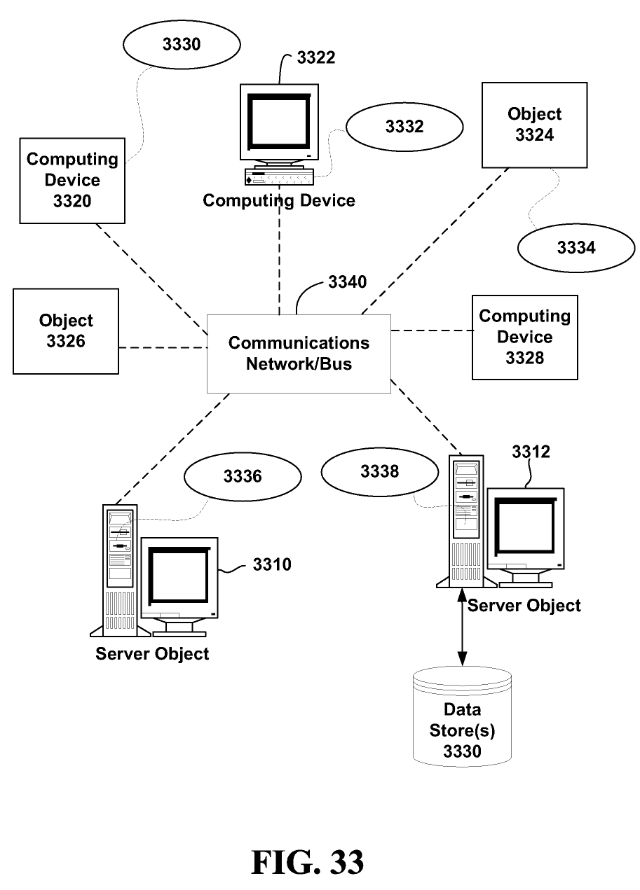

FIG. 33 provides a schematic diagram of an exemplary networked or distributed computing environment. The distributed computing environment comprises computing objects 3310, 3312, etc. and computing objects or devices 3320, 3322, 3324, 3326, 3328, etc., which may include programs, methods, data stores, programmable logic, etc., as represented by applications 3330, 3332, 3334, 3336, 3338. It can be appreciated that objects 3310, 3312, etc. and computing objects or devices 3320, 3322, 3324, 3326, 3328, etc. may comprise different devices, such as PDAs, audio/video devices, mobile phones, MP3 players, personal computers, laptops, etc.

Each object 3310, 3312, etc. and computing objects or devices 3320, 3322, 3324, 3326, 3328, etc. can communicate with one or more other objects 3310, 3312, etc. and computing objects or devices 3320, 3322, 3324, 3326, 3328, etc. by way of the communications network 3340, either directly or indirectly. Even though illustrated as a single element in FIG. 33, network 3340 may comprise other computing objects and computing devices that provide services to the system of FIG. 33, and/or may represent multiple interconnected networks, which are not shown. Each object 3310, 3312, etc. or 3320, 3322, 3324, 3326, 3328, etc. can also contain an application, such as applications 3330, 3332, 3334, 3336, 3338, that might make use of an API, or other object, software, firmware and/or hardware, suitable for communication with, processing for, or implementation of the column based encoding and query processing provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the column based encoding and query processing as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 33, as a non-limiting example, computers 3320, 3322, 3324, 3326, 3328, etc. can be thought of as clients and computers 3310, 3312, etc. can be thought of as servers where servers 3310, 3312, etc. provide data services, such as receiving data from client computers 3320, 3322, 3324, 3326, 3328, etc., storing of data, processing of data, transmitting data to client computers 3320, 3322, 3324, 3326, 3328, etc., although any computer can be considered a client, a server, or both, depending on the circumstances. Any of these computing devices may be processing data, encoding data, querying data or requesting services or tasks that may implicate the column based encoding and query processing as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the column based encoding and query processing can be provided standalone, or distributed across multiple computing devices or objects.

In a network environment in which the communications network/bus 3340 is the Internet, for example, the servers 3310, 3312, etc. can be Web servers with which the clients 3320, 3322, 3324, 3326, 3328, etc. communicate via any of a number of known protocols, such as the hypertext transfer protocol (HTTP). Servers 3310, 3312, etc. may also serve as clients 3320, 3322, 3324, 3326, 3328, etc., as may be characteristic of a distributed computing environment.

### Exemplary Computing Device

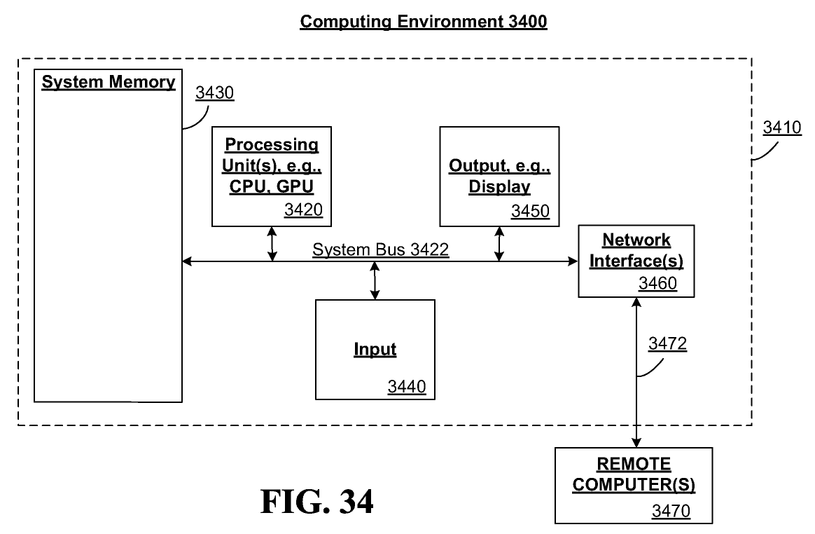

As mentioned, advantageously, the techniques described herein can be applied to any device where it is desirable to query large amounts of data quickly. It should be understood, therefore, that handheld, portable and other computing devices and computing objects of all kinds are contemplated for use in connection with the various embodiments, i.e., anywhere that a device may wish to scan or process huge amounts of data for fast and efficient results. Accordingly, the below general purpose remote computer described below in FIG. 34 is but one example of a computing device.

Although not required, embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 34 thus illustrates an example of a suitable computing system environment 3400 in which one or aspects of the embodiments described herein can be implemented, although as made clear above, the computing system environment 3400 is only one example of a suitable computing environment and is not intended to suggest any limitation as to scope of use or functionality. Neither should the computing environment 3400 be interpreted as having any dependency or requirement relating to any one or combination of components illustrated in the exemplary operating environment 3400.

With reference to FIG. 34, an exemplary remote device for implementing one or more embodiments includes a general purpose computing device in the form of a computer 3410. Components of computer 3410 may include, but are not limited to, a processing unit 3420, a system memory 3430, and a system bus 3422 that couples various system components including the system memory to the processing unit 3420.

Computer 3410 typically includes a variety of computer readable media and can be any available media that can be accessed by computer 3410. The system memory 3430 may include computer storage media in the form of volatile and/or nonvolatile memory such as read only memory (ROM) and/or random access memory (RAM). By way of example, and not limitation, memory 3430 may also include an operating system, application programs, other program modules, and program data.

A user can enter commands and information into the computer 3410 through input devices 3440. A monitor or other type of display device is also connected to the system bus 3422 via an interface, such as output interface 3450. In addition to a monitor, computers can also include other peripheral output devices such as speakers and a printer, which may be connected through output interface 3450.

The computer 3410 may operate in a networked or distributed environment using logical connections to one or more other remote computers, such as remote computer 3470. The remote computer 3470 may be a personal computer, a server, a router, a network PC, a peer device or other common network node, or any other remote media consumption or transmission device, and may include any or all of the elements described above relative to the computer 3410. The logical connections depicted in FIG. 34 include a network 3472, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to compress large scale data or process queries over large scale data.

Also, there are multiple ways to implement the same or similar functionality, e.g., an appropriate API, tool kit, driver code, operating system, control, standalone or downloadable software object, etc. which enables applications and services to use the efficient encoding and querying techniques. Thus, embodiments herein are contemplated from the standpoint of an API (or other software object), as well as from a software or hardware object that provides column based encoding and/or query processing. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention should not be limited to any single embodiment, but rather should be construed in breadth, spirit and scope in accordance with the appended claims.

What is claimed is:

1. A method for processing data, comprising:
in response to a query implicating at least one join operation over data in at least one data store, receiving a subset of data as integer encoded and compressed sequences of values corresponding to different columns of the data in the at least one data store;
determining at least one result set for the at least one join operation including determining if a local cache includes any non-default values corresponding to columns implicated by the at least one join operation; and
where the local cache includes any non-default values corresponding to columns implicated by the at least one join operation, substituting the non-default values when determining the at least one result set.

2. The method of claim 1, further comprising:
storing at least one result of the at least one result set in the local cache for substitution in connection with a second query.

3. The method of claim 2, wherein the storing includes lockless storing of the at least one result in memory.

4. The method of claim 1, wherein the determining includes parallelizing the operations defined by the query with multiple processors and a corresponding number of segments divided from the sequences, each segment handled by at least one different processor.

5. The method of claim 1, further comprising:
setting the local cache to default values prior to initiating query processing.

6. The method of claim 5, wherein the setting includes setting the local cache to values of negative one (“−1”) prior to initiating query processing.

7. The method of claim 1, wherein the substituting includes substituting the non-default values when determining the at least one result set instead of scanning the corresponding column in the sequence of values.

8. The method of claim 1, further comprising,
where the local cache includes default values corresponding to columns implicated by the at least one join operation, processing the corresponding column in the sequence of values to retrieve at least one result for the at least one result set.

9. The method of claim 1, wherein the receiving includes receiving the subset of data from a relational database and wherein the different columns of the data correspond to columns of the relational database.

10. A computer readable medium comprising computer executable instructions for performing the method of claim 1.

11. A method for query processing, including:
generating a lazy cache shared by segments of compacted data retrieved in response to a query as integer encoded and compressed sequences of values corresponding to different columns of the data in at least one data store representing a set of tables; and
in response to a query implicating at least one join operation over data in at least one data store, processing the query with reference to the lazy cache implicating at least one join operation over the at least one data store;
wherein the processing includes populating the lazy cache with at least one data value from at least one table of the set of tables according to a predetermined algorithm for potential re-use of the at least one data value over the lifetime of the query processing.

12. The method of claim 11, wherein the generating includes organizing the lazy cache according to at least one vector with values corresponding to the sequences of values corresponding to the different columns of data.

13. The method of claim 11, wherein the processing further includes scanning the sequences of values wherein the processing includes populating the lazy cache with at least one data value from at least one table of the set of tables according to a predetermined algorithm for potential re-use of the at least one data value over the lifetime of the query processing.

14. The method of claim 11, wherein the processing includes using foreign key data identifications (IDs) from the sequences of values as an index to the lazy cache.

15. The method of claim 14, wherein the processing includes determining if a value of the lazy cache corresponding to a foreign key data ID is a default value.

16. The method of claim 15, wherein if the value of the lazy cache is the default value, performing the at least one join operation over the sequences of values.

17. The method of claim 14, wherein if the value of the lazy cache is not the default value, skipping the at least one join operation over the sequences of values, and using the value of the lazy cache corresponding to the foreign key data ID instead.

18. The method of claim 11, wherein the processing includes receiving a result set and further including writing at least one result of the result set to the lazy cache as an atomic operation of a core processor data type that does not require a lock for consistency.

19. A computing device comprising means for performing the method of claim 11.

20. A device for processing data, comprising:
high speed in memory storage for storing a subset of data received as integer encoded and compressed sequences of values corresponding to different columns of the data and for storing a vector of values corresponding to the different columns; and
at least one query processor that processes the query over the subset of the data and that skips at least one join operation implicated by the query over the subset of data where a default value is found in the vector for a given column and substitutes a value of the vector for the at least one join operation instead.
